(19) United States
(12) Patent Application Publication
(10) Pub. No.: US 2026/0219105 A1
(43) Pub. Date: Jul. 30, 2026

(54) PHOTOELECTRIC CONVERSION DEVICE AND EQUIPMENT

(71) Applicant: CANON KABUSHIKI KAISHA, Tokyo (JP)

(72) Inventor: SHOGO YAMASAKI, Kanagawa (JP)

(21) Appl. No.: 19/455,319

(22) Filed: Jan. 21, 2026

(30) Foreign Application Priority Data
Jan. 27, 2025 (JP) 2025-011539

(51) Int. Cl. G01J 1/44; H04N 25/705; H04N 25/773

(52) U.S. Cl. CPC G01J 1/44; H04N 25/705; H04N 25/773; G01J 2001/4466

(57) ABSTRACT

A photoelectric conversion device includes a light receiving unit including an avalanche photodiode and outputting a photon detection signal in response to incidence of a photon, a first integration unit integrating a first signal weighted based on first weight information with respect to the photon detection signal, a second integration unit integrating a second signal weighted based on second weight information related to weighting of a time-domain correlation for calculating optical flow with respect to the photon detection signal, and a control unit outputting a first control signal for controlling an output of the first signal to the first integration unit and a second control signal for controlling an output of the second signal to the second integration unit. The number of asserted periods of the second control signal in a unit exposure period is smaller than that of the first control signal in the unit exposure period.

### BACKGROUND

### Field of the Technology

The present disclosure relates to a photoelectric conversion device and an equipment.

### Description of the Related Art

A time-domain correlation image sensor is known as one of imaging sensors. S. Ando et al. (Shigeru Ando and Akira Kimachi, “Time-Domain Correlation Imaging and Its Applications”, IEEJ Transactions on Sensors and Micromachines, Volume 129, Issue 5, pp. 129-137 (2009)) discloses, as a time-domain correlation image sensor, a structure in which a correlation detection function is incorporated into a pixel. With this structure, it is possible to detect a time variation pattern of a wider band than the frame rate. In addition, S. Ando et al. discloses, as the correlation detection structure, a structure in which a photodiode that generates a photocurrent and a plurality of capacitors that accumulate the photocurrent are provided.

However, in the time-domain correlation image sensor described in S. Ando et al., the correlation detection function is incorporated into the pixel, whereby the circuit scale of the pixel must be increased, and an increase in the size of the photoelectric conversion device cannot be avoided.

### SUMMARY

The present disclosure is directed to provide a technique for reducing a circuit scale of a pixel in a photoelectric conversion device having a function of time-domain correlation imaging.

According to one disclosure of the present specification, there are provided a photoelectric conversion device including a light receiving unit including an avalanche photodiode and configured to output a photon detection signal in response to incidence of a photon, a first integration unit configured to integrate a first signal obtained by weighting the photon detection signal based on first weight information, a second integration unit configured to integrate a second signal obtained by weighting the photon detection signal based on second weight information related to weighting of a time-domain correlation for calculating an optical flow, and a control unit configured to output a first control signal that controls an output of the first signal from the light receiving unit to the first integration unit and a second control signal that controls an output of the second signal from the light receiving unit to the second integration unit, wherein number of asserted periods of the second control signal in a unit exposure period is smaller than number of asserted periods of the first control signal in the unit exposure period.

Further, according to another disclosure of the present specification, there is provided a method of driving a photoelectric conversion device including a light receiving unit including an avalanche photodiode and configured to output a photon detection signal in response to incidence of a photon, a first integration unit configured to integrate a first signal obtained by weighting the photon detection signal based on first weight information, and a second integration unit configured to integrate a second signal obtained by weighting the photon detection signal based on second weight information related to weighting of a time-domain correlation for calculating an optical flow, the method including controlling an output of the first signal from the light receiving unit to the first integration unit by a first control signal, and controlling an output of the second signal from the light receiving unit to the second integration unit by a second control signal in which number of asserted periods per unit exposure period is smaller than that of the first control signal.

Features of the present disclosure will become apparent from the following description of embodiments with reference to the attached drawings. The following description of embodiments is described by way of example.

### BRIEF DESCRIPTION OF THE DRAWINGS

FIG. 1 and FIG. 2 are block diagrams illustrating schematic configurations of a photoelectric conversion device according to a first embodiment.

FIG. 3 is a block diagram illustrating a schematic configuration of a pixel in the photoelectric conversion device according to the first embodiment.

FIG. 4 is a perspective view illustrating a configuration example of the photoelectric conversion device according to the first embodiment.

FIG. 5A, FIG. 5B, FIG. 5C, FIG. 6A, FIG. 6B, FIG. 6C, and FIG. 6D are diagrams illustrating basic operations of the photoelectric conversion unit in the photoelectric conversion device according to the first embodiment.

FIG. 7 is a functional block diagram illustrating a schematic configuration of a weight control unit in the photoelectric conversion device according to the first embodiment.

FIG. 8 is a functional block diagram illustrating a schematic configuration of the pixel in the photoelectric conversion device according to the first embodiment.

FIG. 9 is a circuit diagram illustrating a configuration example of the pixel in the photoelectric conversion device according to the first embodiment.

FIG. 10 is a diagram illustrating an example of a relationship between a main frame period and a subframe period and a temporal change of a weighting amount.

FIG. 11, FIG. 12, and FIG. 13 are timing charts illustrating the operation of the pixel in the photoelectric conversion device according to the first embodiment.

FIG. 14 is a functional block diagram illustrating a schematic configuration of pixels in a photoelectric conversion device according to a second embodiment.

FIG. 15 is a circuit diagram illustrating a configuration example of the pixels in the photoelectric conversion device according to the second embodiment.

FIG. 16 is a block diagram illustrating a schematic configuration of a photoelectric conversion system according to a third embodiment.

FIG. 17A is a diagram illustrating a configuration example of a photoelectric conversion system according to a fourth embodiment.

FIG. 17B is a diagram illustrating a configuration example of a movable object according to the fourth embodiment.

FIG. 18 is a block diagram illustrating a schematic configuration of an equipment according to a fifth embodiment.

### DESCRIPTION OF THE EMBODIMENTS

Hereinafter, embodiments of the present disclosure will be described in detail with reference to the accompanying drawings. In each of the embodiments described below, a photoelectric conversion device for imaging purposes will be mainly described as an example of a photoelectric conversion device. However, the embodiments are not limited to photoelectric conversion devices for imaging purposes and may be applied to other photoelectric conversion devices. For example, other examples of the photoelectric conversion device include a ranging device (a device for distance measurement and the like using a focus detection or a time of flight (TOF)), a photometric device (a device for measuring the amount of incident light), and the like.

Note that the conductivity type of each of the transistors described in the embodiments described below is merely an example and is not limited to the conductivity type described in the embodiments. The conductivity type may be appropriately changed with respect to the conductivity type described in the embodiments, and the potentials of the gate, the source, and the drain of the transistor may be appropriately changed in accordance with the change. For example, in the case of a transistor operating as a switch, low-level and high-level of the potential supplied to the gate may be reversed with respect to the description in the embodiment as the conductivity type is changed.

In the following embodiments, connection between elements of a circuit may be described. In this case, even when another element is interposed between the elements of interest, the elements of interest are considered to be connected to each other unless otherwise specified. For example, it is assumed that an element A is connected to one node of a capacitor C having a plurality of nodes, and an element B is connected to the other node of the capacitor. Even in such a case, the element A and the element B are regarded as being connected to each other unless otherwise specified.

### First Embodiment

Prior to the description of a photoelectric conversion device according to a first embodiment, the principles of a time-domain correlation image sensor and an event-based sensor will be schematically described.

A time-domain correlation image sensor includes a photodiode and a configuration for acquiring a signal output from the photodiode divided into plural parts. A signal for each pixel that generates an image is expressed by the following Expression (1).

$$( υ \cdot ∇ + \frac{\partial }{\partial t} ) f ( x , y , t ) = 0 \qquad ( 1 )$$

Where f (x, y, t) is a brightness of a pixel (x, y) at time t. v is a velocity of the pixel (x, y) (time differential of the pixel (x, y)). ∇ is a nabla operator (vector differential operator).

Assuming that an exposure time in acquisition of an image of one frame is T, an image gₙ (x, y) is expressed by the following Expression (2).

$${g}_{n} ( x , y ) = {\int }_{0}^{T} f ( x , y , t ) \cdot {e}^{- i \cdot n \cdot {Δ}_{ω} \cdot t} dt , {Δ}_{ω} = \frac{2 π}{T} \qquad ( 2 )$$

As shown in the Expression (2), the image gₙ (x, y) is obtained by multiplying the brightness f (x, y, t) by the reference signal represented by the complex number e^{-inΔwt} and integrating the result in the range of one frame period. Here, it is assumed that the captured image gₙ (x, y) satisfies the following Expression (3).

$$υ \cdot ∇ {g}_{n} ( x , y ) + {[ f ( x , y , t ) ]}_{0}^{T} + i \cdot n \cdot {Δ}_{ω} {g}_{n} ( x , y ) = 0 {,}^{∀} n = 0 , 1 , 2 … \qquad ( 3 )$$

The second term on the left side of the Expression (3) indicates a boundary value of integration. Since the Expression (3) is a plurality of expressions different from each other according to the value of n, it forms simultaneous equations. Therefore, by solving the simultaneous equations using, for example, two images g₀ (x, y) and g₁ (x, y), it is possible to eliminate the boundary value of integration. The time-domain correlation image sensor may output an intensity image g₀ (x, y) consisting of only the real part, and a real part and an imaginary part of a complex correlation image gₙ (x, y) (hereinafter, the complex correlation image is also referred to as a time-domain correlation signal). Therefore, by substituting the output signal of the time-domain correlation image sensor into the simultaneous equations of the Expression (3) and solving them, it is possible to obtain the velocity v, that is, the optical flow in each pixel (x, y).

In the signal processing of the time-domain correlation image sensor, it is necessary to calculate the integral of the range of one frame period as shown in the Expression (2). Therefore, the output timing of the correlation image is limited to the unit of one frame period. In the time-domain correlation image sensor, the cycle of the reference signal and the cycle of the shutter opening period are made to coincide with each other. Therefore, the correlation image is output at a frequency corresponding to the cycle of the shutter opening period.

An event-based sensor will now be outlined. The event-based sensor detects a change in brightness within the imaging range and outputs an event signal each time a change in brightness is detected. The event-based sensor includes a plurality of pixels arranged, for example, in a matrix. That is, the event signal is a signal associated with an event, and the event is a luminance change of a pixel. As one example, the event signal includes a time at which an event is detected, a position of a pixel at which the event is detected, and a change in a pixel value. The time at which the event is detected may be measured based on the time (event camera time) indicated by the internal clock of the event-based sensor.

Note that the reference of the time at which the event is detected may be reset as necessary. The change in the pixel value is, for example, a change in luminance. The change in the pixel value may be the amount of change itself or may be information indicating whether the luminance change is positive or negative.

The event-based sensor outputs an event signal when a luminance change occurs and does not output an event signal when a luminance change does not occur. That is, the event-based sensor asynchronously outputs the event signal. Note that asynchronously outputting means outputting a signal in units of pixels independently in terms of time.

The operation of the event-based sensor is expressed by the following Expression (4).

$$Y ( x , y , t ) = Y ( x , y , {t}_{0} ) + Δ Y {\sum }_{i} {\int }_{{t}_{0}}^{t} d s δ ( s - {s}_{i} ) \cdot p ( x , y , {s}_{i} ) \qquad ( 4 )$$

Y (x, y, t) in Expression (4) is an image at time t. Time to is the measurement start time. The image Y (x, y, t₀) is an initial image stored at the time t₀. In general, the image Y (x, y, t₀) may be zero. ΔY is a threshold value (absolute value of luminance change) of occurrence of an event. p (x, y, sᵢ) is an i-th event signal that occurs in the pixel (x, y), and the value of p (x, y, sᵢ) at the time of event detection is 1 or −1 depending on whether the luminance change is positive or negative. δ (s−sᵢ) is a Dirac delta function.

The event-based sensor may be provided with the ability to output a time-domain correlation signal, such as a time-domain correlation image sensor. In a case where the time t is the end time of the frame period, the output signal of the time-domain correlation image sensor may be expressed by the following Expressions (5) to (7) using the angular velocity ω (ω=2π/T).

$${g}_{0} ( x , y , t ) = {\int }_{t - T}^{t} f ( x , y , s ) ds \qquad ( 5 )$$

$$Re {g}_{1} ( x , y , t ) = {\int }_{t - T}^{t} cos ( ω ( s - t ) ) f ( x , y , s ) ds \qquad ( 6 )$$

$$Im {g}_{1} ( x , y , t ) = {\int }_{t - T}^{t} sin ( ω ( s - t ) ) f ( x , y , s ) ds \qquad ( 7 )$$

In the time-domain correlation image sensor, a charge based on a current output from a photodiode is accumulated in a capacitor. The accumulated charge corresponds to luminance. On the other hand, in the event-based sensor, a signal obtained by quantizing a change in current output from the photodiode is output. Therefore, in the event-based sensor, the output from the photodiode at the time s may be divided into a localization term f (x, y, t−T) having a constant value within the measurement period and a displacement term δf (x, y, s) corresponding to the difference with respect to the localization term. Therefore, f (x, y, s) is expressed by the following Expression (8).

$$f ( x , y , s ) = f ( x , y , t - T ) + δ f ( x , y , s ) \qquad ( 8 )$$

Considering the properties of the reference signal, the following Expressions (9) and (10) are satisfied.

$${\int }_{t - T}^{t} cos ( ω \cdot s ) ds = 0 \qquad ( 9 )$$

$${\int }_{t - T}^{t} sin ( ω \cdot s ) ds = 0 \qquad ( 10 )$$

Using the relationships of Expressions (9) and (10), Expressions (5) to (7) may be rewritten to expressions using a localization term and a displacement term. As a result, the following Expressions (11) to (13) are obtained.

$${g}_{0} ( x , y , t ) = Y ( x , y , t - T ) + {\int }_{t - T}^{t} δ f ( x , y , s ) ds \qquad ( 11 )$$

$$Re {g}_{1} ( x , y , t ) = {\int }_{t - T}^{t} cos ( ω ( s - t ) ) f ( x , y , s ) ds \qquad ( 12 )$$

$$Im {g}_{1} ( x , y , t ) = {\int }_{t - T}^{t} sin ( ω ( s - t ) ) f ( x , y , s ) ds \qquad ( 13 )$$

For the event-based sensor, the current output by the photodiode of the time-domain correlation image sensor is converted into an event signal of the event-based sensor, as represented by the following Expression (14).

$$δ f ( x , y , s ) \to Δ Y {\sum }_{i} δ ( s - {s}_{i} ) \cdot p ( x , y , {s}_{i} ) \qquad ( 14 )$$

As a result, the Expressions (11) to (13) may be transformed into the following Expressions (15) to (17).

$${g}_{0} ( x , y , t ) = Y ( x , y , t - T ) + Δ Y {\int }_{t - T}^{t} δ ( s - {s}_{i} ) \cdot p ( s , y , {s}_{i} ) ds \qquad ( 15 )$$

$$Re {g}_{1} ( x , y , t ) = Δ Y {\int }_{t - T}^{t} cos ( ω ( s - t ) ) {\sum }_{i} δ ( s - {s}_{i} ) \cdot p ( x , y , {s}_{i} ) ds \qquad ( 16 )$$

$$Im {g}_{1} ( x , y , t ) = Δ Y {\int }_{t - T}^{t} sin ( ω ( s - t ) ) {\sum }_{i} δ ( s - {s}_{i} ) \cdot p ( x , y , {s}_{i} ) d s \qquad ( 17 )$$

As shown in the Expressions (15) to (17), it is possible to output the time-domain correlation signal by using the event signal generated during the period (cycle T) in which the signal is acquired.

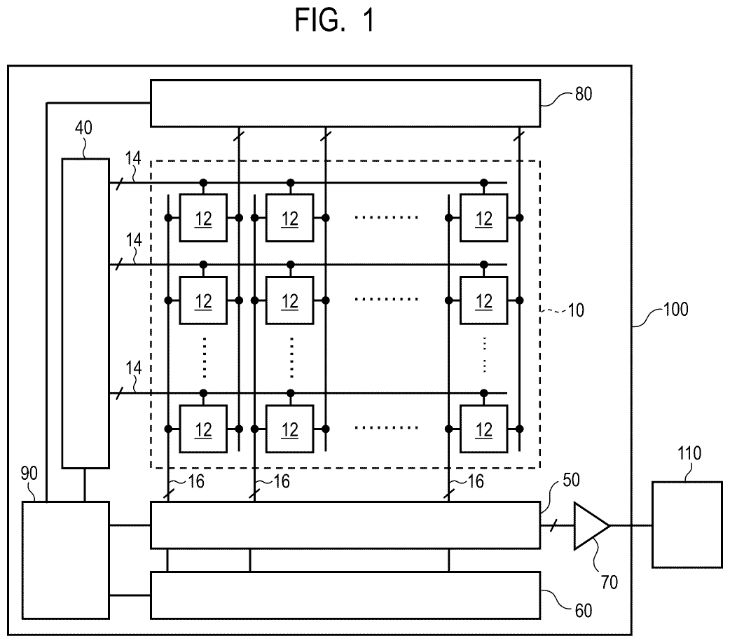

Next, a schematic configuration of a photoelectric conversion device according to a first embodiment will be described with reference to FIG. 1. FIG. 1 is a block diagram illustrating a schematic configuration of a photoelectric conversion device according to the present embodiment.

As illustrated in FIG. 1, the photoelectric conversion device 100 according to the present embodiment includes a pixel unit 10, a vertical scanning circuit unit 40, a readout circuit unit 50, a horizontal scanning circuit unit 60, an output circuit unit 70, a weight control unit 80, and a control pulse generation unit 90.

The pixel unit 10 is provided with a plurality of pixels 12 arranged in a plurality of rows and a plurality of columns. Each pixel 12 may include a photoelectric conversion unit including a photoelectric conversion element and a signal processing unit that processes a signal output from the photoelectric conversion unit. The number of pixels 12 included in the pixel unit 10 is not particularly limited. For example, like a general digital camera, the pixel unit 10 may be constituted by a plurality of pixels 12 arranged in an array of several thousand rows x several thousand columns. Alternatively, the pixel unit 10 may include a plurality of pixels 12 arranged in one row or one column. Alternatively, the pixel unit 10 may include one pixel 12. A specific configuration and operation of the pixel 12 will be described later.

In each row of the pixel array of the pixel unit 10, a control line 14 is arranged so as to extend in a first direction (lateral direction in FIG. 1). Each of the control lines 14 is connected to the pixels 12 arranged in the first direction on the corresponding row, respectively, and forms a signal line common to these pixels 12. The first direction in which the control lines 14 extend may be referred to as a row direction or a horizontal direction. Each of the control lines 14 may include a plurality of signal lines for supplying a plurality of types of control signals to the pixels 12.

Further, in each column of the pixel array of the pixel unit 10, output lines 16 are arranged so as to extend in a second direction (vertical direction in FIG. 1) intersecting the first direction. Each of the output lines 16 is connected to the pixels 12 arranged in the second direction on the corresponding column, respectively, and forms a signal line common to these pixels 12. The second direction in which the output lines 16 extend may be referred to as a column direction or a vertical direction. Each of the output lines 16 may include a plurality of signal lines. For example, the output line 16 may include a plurality of signal lines for transferring a digital signal of a plurality of bits output from the pixel 12 on a bit-by-bit basis.

Each of the plurality of pixels 12 constituting the pixel unit 10 is connected to the weight control unit 80. The weight control unit 80 and each of the plurality of pixels 12 may be connected by a plurality of signal lines. In FIG. 1, the weight control unit 80 and the pixels 12 are connected to each other via the signal lines arranged in each column of the pixel array, but the connection mode between the weight control unit 80 and the pixels 12 is not limited to the example of FIG. 1.

The control line 14 of each row is connected to the vertical scanning circuit unit 40. The vertical scanning circuit unit 40 is a control circuit having a function of generating a control signal for driving the pixels 12 in accordance with a control signal from the control pulse generation unit 90 and supplying the generated control signal to the pixels 12 via the control line 14. A logic circuit such as a shift register or an address decoder may be used as the vertical scanning circuit unit 40. The vertical scanning circuit unit 40 sequentially scans the pixels 12 in the pixel unit 10 row by row and causes the pixels 12 to output pixel signals to the readout circuit unit 50 via the output lines 16.

The output line 16 of each column is connected to the readout circuit unit 50. The readout circuit unit 50 has a function of holding a pixel signal output from each column of the pixel array via the output line 16 in a holding unit provided corresponding to each column. The readout circuit unit 50 may further include a function of performing predetermined arithmetic processing on the pixel signal read out from the pixel unit 10. The arithmetic processing executed by the readout circuit unit 50 may include processing related to time-domain correlation imaging.

The horizontal scanning circuit unit 60 is a control circuit that generates a control signal for reading out a pixel signal from the holding unit of each column of the readout circuit unit 50 in accordance with a control signal output from the control pulse generation unit 90 and supplies the generated control signal to the readout circuit unit 50. A logic circuit such as a shift register or an address decoder may be used as the horizontal scanning circuit unit 60. The horizontal scanning circuit unit 60 sequentially scans the holding units of each column of the readout circuit unit 50 and causes the holding units to sequentially output the pixel signals held therein to the output circuit unit 70.

The output circuit unit 70 is a circuit unit for outputting the pixel signals output from the readout circuit unit 50 to a signal processing device 110 outside the photoelectric conversion device 100 and includes an external interface circuit. The external interface circuit included in the output circuit unit 70 is not particularly limited. As the external interface circuit, for example, a serializer/deserializer (SerDes) transmission circuit may be applied. Examples of the SerDes transmission circuit include a low voltage differential signaling (LVDS) circuit and a scalable low voltage signaling (SLVS) circuit.

The weight control unit 80 has a function of controlling weighting (weighting amount) on a signal generated by the pixel 12. Specifically, the weight control unit 80 generates a first weight signal and a second weight signal and outputs at least one of the first weight signal and the second weight signal to each of the plurality of pixels 12 configuring the pixel unit 10. The weight control unit 80 may also be said to be a weight signal generation unit that generates a first weight signal and a second weight signal. A specific configuration and operation of the weight control unit 80 will be described later.

The control pulse generation unit 90 is a control circuit for generating control signals for controlling the operations and timings thereof of the vertical scanning circuit unit 40, the readout circuit unit 50, the horizontal scanning circuit unit 60, and the weight control unit 80, and supplying the generated control signals to each functional block. At least a part of the control signals for controlling the operation and timing of each functional block may be supplied from the outside of the photoelectric conversion device 100.

The signal processing device 110 is a functional block that performs predetermined signal processing on a signal output from the photoelectric conversion device 100. The signal processing device 110 may perform processing related to time-domain correlation imaging such as calculation of an optical flow using a signal output from the photoelectric conversion device 100. This processing may be based on, for example, Expressions (1) to (17) described above. Note that the signal processing device 110 may be provided inside the photoelectric conversion device 100 or may be provided in an equipment on which the photoelectric conversion device 100 is mounted. In a case where the function of the signal processing device 110 is provided in the photoelectric conversion device 100, the photoelectric conversion device 100 may perform predetermined arithmetic processing on the pixel signal in a stage preceding the output circuit unit 70, for example, in the readout circuit unit 50.

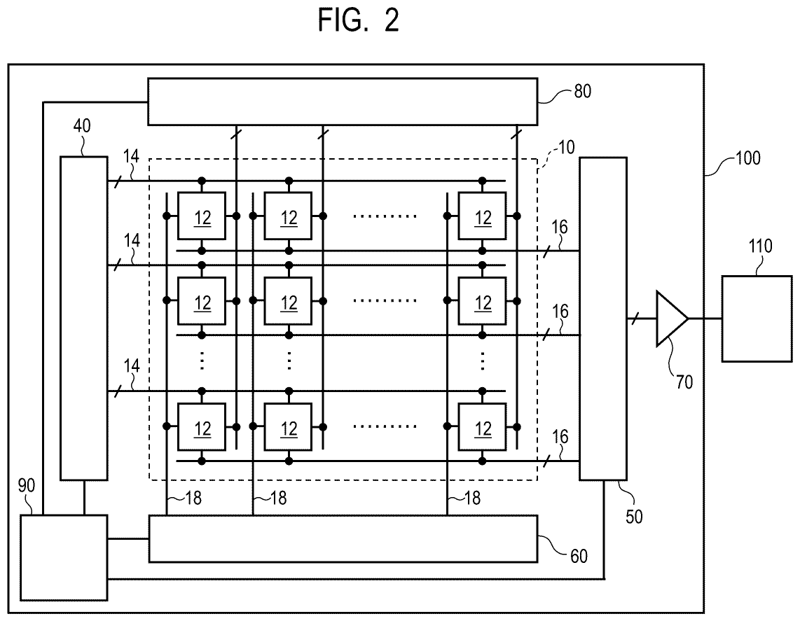

The connection mode of each functional block of the photoelectric conversion device 100 is not limited to the configuration example of FIG. 1 and may be configured as illustrated in FIG. 2, for example.

In the configuration example of FIG. 2, the output line 16 extending in the first direction is arranged in each row of the pixel array of the pixel unit 10. Each of the output lines 16 is connected to the pixels 12 arranged in the first direction on the corresponding row, respectively, and forms a signal line common to these pixels 12. A control line 18 extending in the second direction is arranged in each column of the pixel array of the pixel unit 10. Each of the control lines 18 is connected to the pixels 12 arranged in the second direction on the corresponding column, respectively, and forms a signal line common to these pixels 12.

The control line 18 of each column is connected to the horizontal scanning circuit unit 60. The horizontal scanning circuit unit 60 generates a control signal for reading out a pixel signal from the pixel 12 in accordance with a control signal output from the control pulse generation unit 90 and supplies the generated control signal to the pixel 12 via the control line 18. Specifically, the horizontal scanning circuit unit 60 sequentially scans the plurality of pixels 12 of the pixel unit 10 in units of columns and causes the pixels 12 of each row belonging to the selected column to output the pixel signals to the readout circuit unit 50 via the output lines 16. Note that it is also possible to adopt a configuration in which the pixel signals of the pixels 12 in each column are sequentially transferred to the readout circuit unit 50 by providing the holding units constituting the shift registers for each row in the pixels 12 and sequentially transferring the pixel signals to the holding units of the adjacent pixels 12.

The readout circuit unit 50 includes a plurality of holding units (not illustrated) provided corresponding to each row of the pixel array of the pixel unit 10 and has a function of holding the pixel signals of the pixels 12 of each row output in units of columns from the pixel unit 10 via the output lines 16 in the holding units of the corresponding rows. In addition, the readout circuit unit 50 receives the control signal output from the control pulse generation unit 90 and causes the holding units of the respective rows to sequentially output the pixel signals held therein to the output circuit unit 70.

Other configurations in the configuration example of FIG. 2 may be the same as those in the configuration example of FIG. 1.

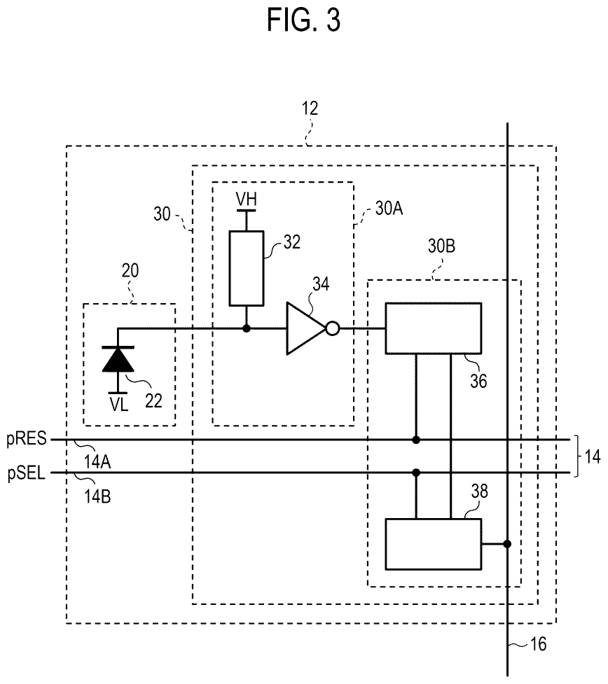

FIG. 3 is a block diagram illustrating a schematic configuration of the pixel 12. As illustrated in FIG. 3, each pixel 12 includes a photoelectric conversion unit 20 and a signal processing unit 30. The photoelectric conversion unit 20 includes a photoelectric conversion element 22, and outputs a signal according to incident light. The signal processing unit 30 is a signal processing circuit that processes a signal output from the photoelectric conversion unit 20. The signal processing unit 30 may include, for example, a functional block 30A including the quenching element 32 and the waveform shaping circuit 34, and a functional block 30B including the processing circuit 36 and the selection circuit 38. In the case of the pixel configuration illustrated in FIG. 3, the control line 14 of each row may include, for example, a signal line 14A to which the control signal PRES is supplied from the vertical scanning circuit unit 40 and a signal line 14B to which the control signal PSEL is supplied from the vertical scanning circuit unit 40.

The photoelectric conversion element 22 may be an avalanche photodiode (hereinafter referred to as “APD”). An anode of the APD constituting the photoelectric conversion element 22 is connected to a node to which a voltage VL is supplied. A cathode of the APD constituting the photoelectric conversion element 22 is connected to one terminal of the quenching element 32. A connection node between the photoelectric conversion element 22 and the quenching element 32 is an output node of the photoelectric conversion unit 20. The other terminal of the quenching element 32 is connected to a node to which a voltage VH higher than the voltage VL is supplied. The voltage VL and the voltage VH are set so that a reverse bias voltage sufficient for the APD to perform the avalanche multiplication operation is applied. In one example, a negative high voltage is applied as the voltage VL, and a positive voltage comparable to a power supply voltage is applied as the voltage VH. For example, the voltage VL is-30 V, and the voltage VH is +1 V.

The photoelectric conversion element 22 may be configured by an APD as described above. When a reverse bias voltage sufficient to perform the avalanche multiplication operation is supplied to the APD, carriers generated by light incident on the APD cause avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than the breakdown voltage of the APD. The linear mode is an operation mode in which a voltage applied between the anode and the cathode is set to a reverse bias voltage close to or lower than the breakdown voltage of the APD. An APD that operates in Geiger mode is referred to as a single photon avalanche diode (SPAD). The APD constituting the photoelectric conversion element 22 may be operated in the linear mode or in the Geiger mode, but the SPAD having a larger potential difference than that in the linear mode APD and having a remarkable improvement effect of the signal-to-noise ratio is more preferable.

Although the anode of the APD is set to a fixed potential and a signal is extracted from the cathode side in the circuit configuration of FIG. 3, the cathode of the APD may be set to a fixed potential and a signal may be extracted from the anode side. In the former case, the signal charge is an electron. In the latter case, the signal charge is a hole. Further, in the present embodiment, a case where one node of the APD is set to a fixed potential will be described, but the potentials of both nodes may vary.

The quenching element 32 has a function of converting a change in the avalanche current generated in the photoelectric conversion element 22 into a voltage signal. In addition, the quenching element 32 functions as a load circuit (quenching circuit) at the time of signal multiplication by avalanche multiplication and has a function of suppressing avalanche multiplication by reducing a voltage applied to the photoelectric conversion element 22. The operation in which the quenching element 32 suppresses avalanche multiplication is called a quenching operation. The quenching element 32 has a function of returning the voltage supplied to the photoelectric conversion element 22 to the voltage VH by flowing a current corresponding to the voltage drop due to the quenching operation. The operation of returning the voltage supplied to the photoelectric conversion element 22 to the voltage VH by the quenching element 32 is called a recharge operation. The quenching element 32 may be configured by a resistor, a MOS transistor, or the like.

The waveform shaping circuit 34 includes an input node to which the output signal of the photoelectric conversion unit 20 is supplied and an output node. The waveform shaping circuit 34 has a function of converting an analog signal supplied from the photoelectric conversion unit 20 into a pulse signal. The waveform shaping circuit 34 may be constituted by a logic circuit including a NOT circuit (inverter circuit), a NOR circuit, a NAND circuit, or the like. An output node of the waveform shaping circuit 34 is connected to the processing circuit 36.

The processing circuit 36 has an input node to which the output signal of the waveform shaping circuit 34 is supplied, an input node connected to the control line 14, and an output node. The processing circuit 36 has a function of performing predetermined signal processing on the output signal of the waveform shaping circuit 34 and holding the processed signal or the processing result. Although not particularly limited, the processing circuit 36 may include, for example, a counter circuit. In this case, the processing circuit 36 counts pulses superimposed on the signal output from the waveform shaping circuit 34 and holds a count value which is a count result. The signal supplied from the vertical scanning circuit unit 40 to the processing circuit 36 via the control line 14 may include an enable signal for controlling a pulse counting period (exposure period), a reset signal for resetting a count value held by the processing circuit 36, and the like. FIG. 3 illustrates, as an example, a reset signal (control signal PRES) supplied via the signal line 14A. The output node of the processing circuit 36 is connected to the selection circuit 38.

The selection circuit 38 has a function of switching an electrical connection state (connection or non-connection) between the processing circuit 36 and the output line 16. The selection circuit 38 switches the connection state between the processing circuit 36 and the output line 16 according to a selection signal supplied from the vertical scanning circuit unit 40 via the control line 14 (or a selection signal supplied from the horizontal scanning circuit unit 60 via the control line 18 in a case where the configuration example of FIG. 2 is applied). FIG. 3 illustrates, as an example, a selection signal (control signal PSEL) supplied via the signal line 14B. The processing circuit 36 may include a buffer circuit for outputting signals.

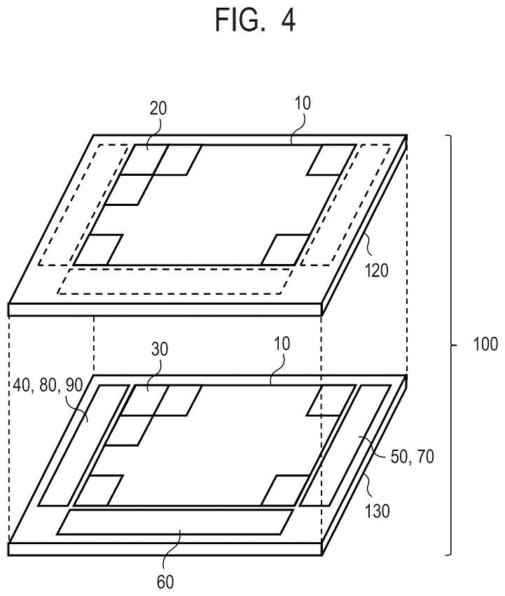

The photoelectric conversion device 100 according to the present embodiment may be formed on one substrate or may be configured as a stacked-type photoelectric conversion device in which a plurality of substrates is stacked. In the latter case, as illustrated in, e.g., FIG. 4, the photoelectric conversion device may be configured as a stacked-type photoelectric conversion device in which the sensor substrate 120 and the circuit substrate 130 are stacked and electrically connected to each other. At least the photoelectric conversion unit 20 among the constituent elements of the pixels 12 may be arranged on the sensor substrate 120. In addition, the signal processing unit 30 among the constituent elements of the pixel 12 may be arranged on the circuit substrate 130. The photoelectric conversion unit 20 and the signal processing unit 30 are electrically connected to each other via an interconnection provided for each pixel 12. The circuit substrate 130 may further include a vertical scanning circuit unit 40, a readout circuit unit 50, a horizontal scanning circuit unit 60, an output circuit unit 70, a weight control unit 80, and a control pulse generation unit 90.

The photoelectric conversion unit 20 and the signal processing unit 30 of each pixel 12 may be provided on the sensor substrate 120 and the circuit substrate 130, respectively, so as to overlap each other in a plan view. The vertical scanning circuit unit 40, the readout circuit unit 50, the horizontal scanning circuit unit 60, the output circuit unit 70, the weight control unit 80, and the control pulse generation unit 90 may be arranged around the pixel unit 10 including the plurality of pixels 12. Here, the term “plan view” refers to a view from a direction perpendicular to the surface of the sensor substrate 120.

By configuring the stacked-type photoelectric conversion device 100, it is possible to increase the degree of integration of elements and achieve higher functionality. In particular, by arranging the photoelectric conversion unit 20 and the signal processing unit 30 on different substrates, the photoelectric conversion elements 22 may be arranged at high density without sacrificing the light receiving area of the photoelectric conversion elements 22, and the photon detection efficiency may be improved.

The number of substrates constituting the photoelectric conversion device 100 is not limited to two, and three or more substrates may be stacked to constitute the photoelectric conversion device 100. For example, when the photoelectric conversion device 100 is configured by stacking three substrates, the photoelectric conversion unit 20 among the constituent elements of the pixel 12 may be arranged on the sensor substrate. In addition, the functional block 30A among the constituent elements of the pixels 12 may be arranged on the first circuit substrate, and the functional block 30B among the constituent elements of the pixels 12 may be arranged on the second circuit substrate. By dividing the substrate to be arranged according to the characteristics of the elements constituting each functional block, a suitable manufacturing process may be applied to each element, and the performance of the photoelectric conversion device may be improved.

In FIG. 4, a diced chip is assumed as the sensor substrate 120 and the circuit substrate 130, but the sensor substrate 120 and the circuit substrate 130 are not limited to chips. For example, each of the sensor substrate 120 and the circuit substrate 130 may be a wafer. In addition, the sensor substrate 120 and the circuit substrate 130 may be stacked in a wafer state and then diced or may be stacked and bonded after being formed into chips.

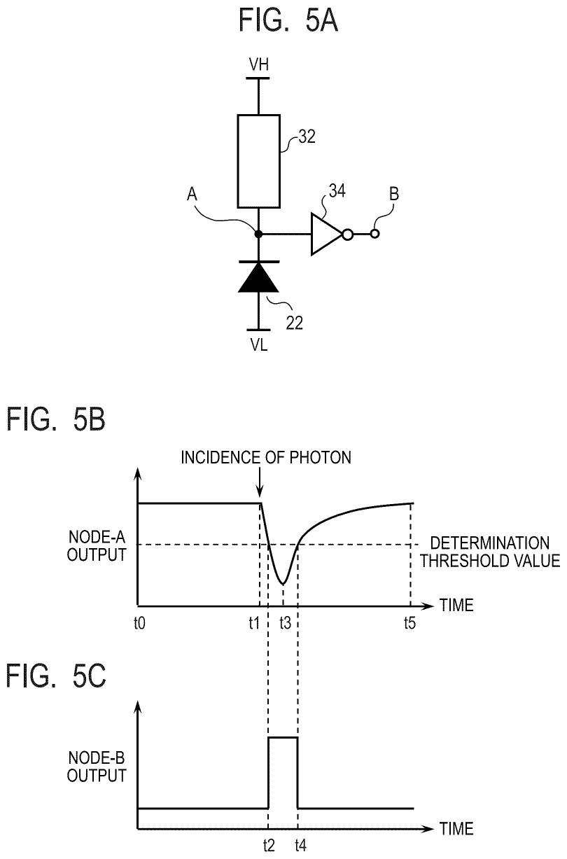

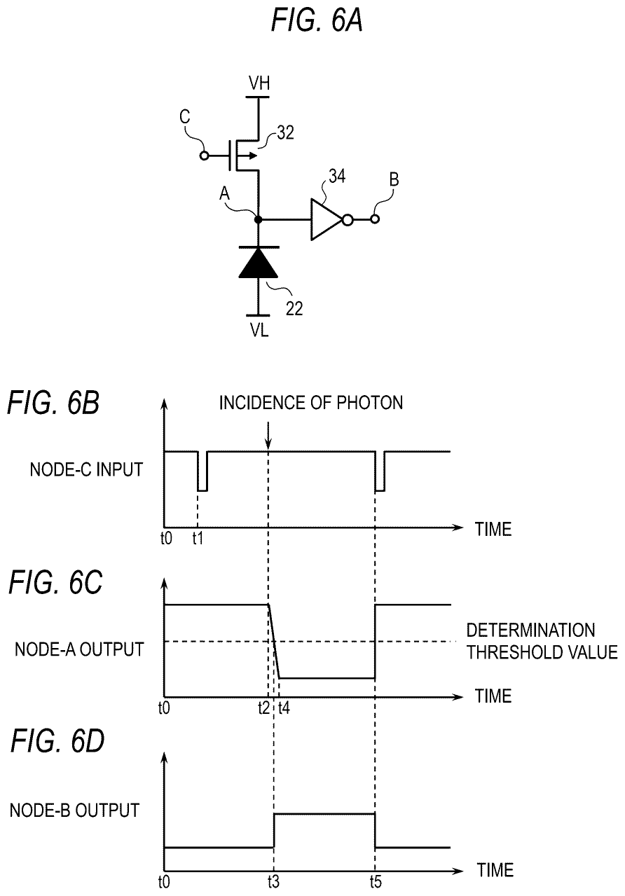

Next, a basic operation of the photoelectric conversion unit 20 in the photoelectric conversion device according to the present embodiment will be described with reference to FIG. 5A to FIG. 6D. FIG. 5A to FIG. 6D are diagrams illustrating basic operations of the photoelectric conversion element 22, the quenching element 32, and the waveform shaping circuit 34 in the photoelectric conversion device according to the present embodiment. FIG. 5A to FIG. 5C illustrate the operation in the case where the quenching element 32 is formed of a passive element, and FIG. 6A to FIG. 6D illustrate the operation in the case where the quenching element 32 is formed of an active element. Here, in order to simplify the description, it is assumed that the waveform shaping circuit 34 is configured by an inverter circuit.

First, an operation in the case where the quenching element 32 is formed of a passive element will be described. Examples of the case where the quenching element 32 is formed of a passive element include a case where the quenching element 32 is formed of a resistor and a case where the quenching element 32 is formed of a diode-connected MOS transistor. FIG. 5A is a circuit diagram of the photoelectric conversion element 22, the quenching element 32, and the waveform shaping circuit 34. FIG. 5B illustrates the waveform of the signal at the input node (node-A) of the waveform shaping circuit 34. FIG. 5C illustrates the waveform of the signal at the output node (node-B) of the waveform shaping circuit 34.

At time to, a reverse bias voltage having a potential difference corresponding to (VH−VL) is applied to the photoelectric conversion element 22. Although a reverse bias voltage sufficient to cause avalanche multiplication is applied between the anode and the cathode of the APD constituting the photoelectric conversion element 22, carriers serving as seeds of avalanche multiplication do not exist in a state where photons are not incident on the photoelectric conversion element 22. Therefore, avalanche multiplication does not occur in the photoelectric conversion element 22, and no current flows through the photoelectric conversion element 22.

At the subsequent time t1, it is assumed that a photon is incident on the photoelectric conversion element 22. When a photon enters the photoelectric conversion element 22, an electron-hole pair is generated by photoelectric conversion, avalanche multiplication occurs using these carriers as seeds, and an avalanche multiplication current flows through the photoelectric conversion element 22. When the avalanche multiplication current flows through the quenching element 32, a voltage drop occurs due to the quenching element 32, and the voltage of the node-A starts to drop. When the voltage drop amount of the node-A becomes large and becomes approximately Vex, avalanche multiplication is stopped at time t3, and the voltage level of the node-A does not drop any more. The potential at which the avalanche multiplication is stopped is about 0 V, that is, a potential at which the voltage applied to the photoelectric conversion element 22 is about Vbd.

When the avalanche multiplication in the photoelectric conversion element 22 stops, a current that compensates for the voltage drop flows from the node of the voltage VH to the node-A via the quenching element 32, and the voltage of the node-A gradually increases. Thereafter, at time t5, the node-A is settled to the original voltage level.

The waveform shaping circuit 34 binarizes the signal input from the node-A according to a predetermined determination threshold value, and outputs the signal from the node-B. Specifically, the waveform shaping circuit 34 outputs a low-level signal from the node-B when the voltage level of the node-A exceeds the determination threshold value and outputs a high-level signal from the node-B when the voltage level of the node-A is equal to or less than the determination threshold value. For example, as illustrated in FIG. 5B, it is assumed that the voltage of the node-A is equal to or lower than the determination threshold value in the period from the time t2 to the time t4. In this case, as illustrated in FIG. 5C, the signal level at the node-B becomes low-level in the period from the time to to the time t2 and the period from the time t4 to the time t5, and becomes high-level in the period from the time t2 to the time t4.

Thus, the analog signal input from the node-A is waveform-shaped into a digital signal by the waveform shaping circuit 34. A pulse signal output from the waveform shaping circuit 34 in response to incidence of a photon on the photoelectric conversion element 22 is a photon detection signal.

Next, an operation when the quenching element 32 is formed of an active element will be described. Examples of the case where the quenching element 32 is formed of an active element include a case where the quenching element 32 is formed of a MOS transistor operated by an external control signal. FIG. 6A is a circuit diagram of the photoelectric conversion element 22, the quenching element 32, and the waveform shaping circuit 34. FIG. 6B illustrates the waveform of the signal at the input node (node-C) of the quenching element 32. FIG. 6C illustrates the waveform of the signal at the input node (node-A) of the waveform shaping circuit 34. FIG. 6D illustrates the waveform of the signal at the output node (node-B) of the waveform shaping circuit 34.

In the circuit of FIG. 6A, the quenching element 32 is formed of a p-channel MOS transistor. A source of the p-channel MOS transistor is connected to the node of the voltage VH, and a drain of the p-channel MOS transistor is connected to the cathode of the photoelectric conversion element 22 and the input node of the waveform shaping circuit 34. A connection node between the drain of the p-channel MOS transistor, the cathode of the photoelectric conversion element 22, and the input node of the waveform shaping circuit 34 is a node-A. To a gate (node-C) of the p-channel MOS transistor, as illustrated in, e.g., FIG. 6B, a periodic pulse signal (hereinafter, referred to as a signal PCLKB) is input. The signal PCLKB includes a periodic falling pulse signal that transitions from high-level to low-level. The p-channel MOS transistor is turned off when the node-C is at high-level to disconnect the node-A from the node of the voltage VH, and is turned on when the node-C is at low-level to reset the node-A to the voltage VH.

When the pulse signal of the signal PCLKB is input to the node-C at time t1, the p-channel MOS transistor is turned on and the node-A is reset to the voltage VH. When the node-C returns to high-level, the p-channel MOS transistor is turned off, and the node-A enters a floating state at the voltage VH.

At the subsequent time t2, it is assumed that a photon is incident on the photoelectric conversion element 22. When a photon enters the photoelectric conversion element 22, an electron-hole pair is generated by photoelectric conversion, avalanche multiplication occurs using these carriers as seeds, and an avalanche multiplication current flows through the photoelectric conversion element 22. When the avalanche multiplication current flows through the quenching element 32, a voltage drop occurs due to the quenching element 32, and the voltage of the node-A starts to drop. When the voltage drop amount of the node-A becomes large and becomes approximately Vex, avalanche multiplication is stopped at time t4, and the voltage level of the node-A does not drop any more. The potential at which the avalanche multiplication is stopped is about 0 V, that is, a potential at which the voltage applied to the photoelectric conversion element 22 is about Vbd. The node-A enters a floating state while being kept at a lowered potential.

When the pulse signal of the signal PCLKB is input to the node-C again at time t5, the p-channel MOS transistor is turned on, and the node-A is reset to the voltage VH again.

The waveform shaping circuit 34 binarizes the signal input from the node-A according to a predetermined determination threshold value, and outputs the signal from the node-B. Specifically, the waveform shaping circuit 34 outputs a low-level signal from the node-B when the voltage level of the node-A exceeds the determination threshold value and outputs a high-level signal from the node-B when the voltage level of the node-A is equal to or less than the determination threshold value. For example, as illustrated in FIG. 6C, it is assumed that the voltage of the node-A is equal to or lower than the determination threshold value in the period from the time t3 to the time t5. In this case, as illustrated in FIG. 6D, the signal level at the node-B becomes low-level in the period from the time t0 to the time t3 and the period after the time t5, and becomes high-level in the period from the time t3 to the time t5.

Thus, the analog signal input from the node-A is waveform-shaped into a digital signal by the waveform shaping circuit 34. A pulse signal output from the waveform shaping circuit 34 in response to incidence of a photon on the photoelectric conversion element 22 is a photon detection pulse signal.

In the operation of FIG. 6B to FIG. 6D, if no photon is incident between the time t1 and time t5, the node-A remains at the voltage VH, and the node-B remains at low-level. In addition, in a case where the photon is incident again during a period from the time when the photon is incident at the time t2 to the time t5, that is, in a state where the potential of the node-A is lowered, the photoelectric conversion element 22 cannot cause further avalanche multiplication. Therefore, the number of incidences of photons that can be detected by the waveform shaping circuit 34 in the period from the time t1 to the time t5 is one at the maximum.

As described above, in the operations of FIG. 6B to FIG. 6D, it is possible to distinguish whether the number of photons incident during one cycle of the pulse signal of the signal PCLKB is 0, or 1 or more. On the other hand, when two or more photons are incident during one cycle of the pulse signal of the signal PCLKB, these photons cannot be distinguished from each other, and a signal detection loss may occur.

In the case where the photons are incident from the next to the next without interruption, in the operations of FIG. 5B and FIG. 5C, the avalanche multiplication in the photoelectric conversion element 22 does not stop and the avalanche current continues to flow, that is, a so-called pile-up state occurs. In this pile-up state, the photon detection pulse signal is not generated, and only the current flows wastefully, which is one problem in the SPAD operation.

On the other hand, in the operations of FIG. 6B to FIG. 6D, when two or more photons are incident during one cycle of the pulse signal of the signal PCLKB, these photons cannot be distinguished from each other, but there is an advantage that pile-up such as that occurring in the operations of FIG. 5B and FIG. 5C does not occur. Although signal detection loss may certainly occur in the operation of FIG. 6B to FIG. 6D, the SPAD originally aims at photon detection in a situation where photon incidence is small, and in such a situation, it is rare that photons are incident a plurality of times during one reset pulse period, and signal detection loss hardly occurs. Therefore, in particular, when the SPAD is used as the image sensor, the operations of FIG. 6B to FIG. 6D are often applied.

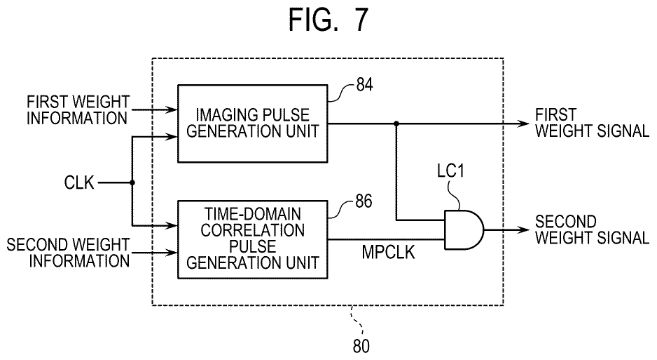

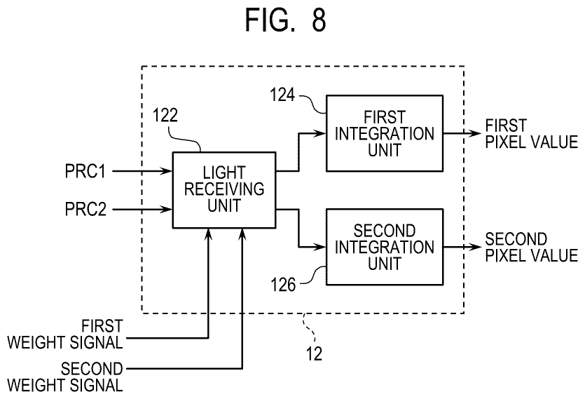

Next, a schematic configuration of the weight control unit 80 and the pixel 12 in the photoelectric conversion device according to the present embodiment will be described with reference to FIG. 7 and FIG. 8. FIG. 7 is a functional block diagram illustrating a schematic configuration of the weight control unit 80 in the photoelectric conversion device according to the present embodiment. FIG. 8 is a functional block diagram illustrating a schematic configuration of the pixel 12 in the photoelectric conversion device according to the present embodiment.

As illustrated in FIG. 7, the weight control unit 80 includes an imaging pulse generation unit 84, a time-domain correlation pulse generation unit 86, and an AND circuit LC1. The weight control unit 80 has a function of performing processing according to first weight information and second weight information on a periodic signal including a periodic pulse signal such as the clock signal CLK and outputting the processed signal as a first weight signal and a second weight signal. Here, the first weight information includes information on a weighting amount for the imaging signal, and the second weight information includes information on a weighting amount for the time-domain correlation signal. The unit exposure period (main frame period) in the photoelectric conversion device according to the present embodiment includes a plurality of sub-exposure periods (subframe periods). The first weight information and the second weight information include information on a weighting amount in each of the plurality of subframe periods constituting the main frame period.

The imaging pulse generation unit 84 generates the first weight signal by, for example, performing thinning processing according to the first weight information on the clock signal CLK. Here, the first weighting information may include the same weighting amount for each of the plurality of subframe periods. The first weight signal may include pulse signals of a number corresponding to a weighting amount according to the first weight information in each subframe period.

The time-domain correlation pulse generation unit 86 generates a multiplied clock signal MPCLK by performing, e.g., a multiplication processing on the clock signal CLK at a magnification corresponding to the second weight information. The multiplied clock signal MPCLK is not necessarily generated by the time-domain correlation pulse generation unit 86 and may be generated by the vertical scanning circuit unit 40 or the control pulse generation unit 90. The multiplication processing of the clock signal CLK may be performed by using, e.g., a PLL (Phase Locked Loop) circuit or the like. At this time, the time-domain correlation pulse generation unit 86 may perform the multiplication processing on the clock signal CLK so that the number of pulse signals corresponding to the weighting amount according to the second weight information is included in the asserted period of the first weight signal, for example. The second weight information may be, for example, information that gives a weighting amount based on a periodic function, for example, a sine function or a cosine function, to each subframe period.

The AND circuit LC1 generates a second weight signal by performing a logical conjunction operation of the first weight signal and the multiplied clock signal MPCLK. That is, the AND circuit LC1 performs thinning processing on the multiplied clock signal MPCLK so that the second weight signal is asserted when the first weight signal and the multiplied clock signal MPCLK are asserted. The asserted state refers to a state in which a signal is in an effective (active) state and typically indicates a case in which the signal is at high-level. On the other hand, a state in which a signal is in an invalid (inactive) state is referred to as a negated state, which typically indicates a case where the signal is at low-level.

The configuration of the internal circuit of the weight control unit 80 is not limited to the above example as long as the weight control unit 80 has a function of generating a first weight signal according to the first weight information and a second weight signal according to the second weight information. The function of the weight control unit 80 may be provided in each of the plurality of pixels 12.

As illustrated in FIG. 8, the pixel 12 may include a light receiving unit 122, a first integration unit 124, and a second integration unit 126. The light receiving unit 122 corresponds to the photoelectric conversion unit 20 and the functional block 30A in the pixel circuit of FIG. 3. The first integration unit 124 and the second integration unit 126 correspond to the processing circuit 36 in the pixel circuit of FIG. 3.

The light receiving unit 122 has a function of receiving the first weight signal, the second weight signal, and the control signals PRC1 and PRC2, and outputting a predetermined number of pulse signals according to incidence of light during the exposure period. The control signals PRC1 and PRC2 may be supplied from the vertical scanning circuit unit 40 or the control pulse generation unit 90. Note that the light receiving unit 122 is not necessarily limited to the configuration described in the present embodiment as long as it has a function of outputting a pulse signal in accordance with incidence of light.

The first integration unit 124 has a function of counting the pulse signal output from the light receiving unit 122 in accordance with the first weight signal and the control signal PRC1. The second integration unit 126 has a function of counting the pulse signal output from the light receiving unit 122 in accordance with the second weight signal and the control signal PRC2. The count value in the first integration unit 124 and the count value in the second integration unit 126 are output from the pixel 12 as a first pixel value and a second pixel value, respectively. An object may be imaged by repeatedly performing the light receiving operation in the light receiving unit 122 and the counting operation in the first integration unit 124 and the second integration unit 126 a predetermined number of times. The details of the control signals PRC1 and PRC2 will be described later.

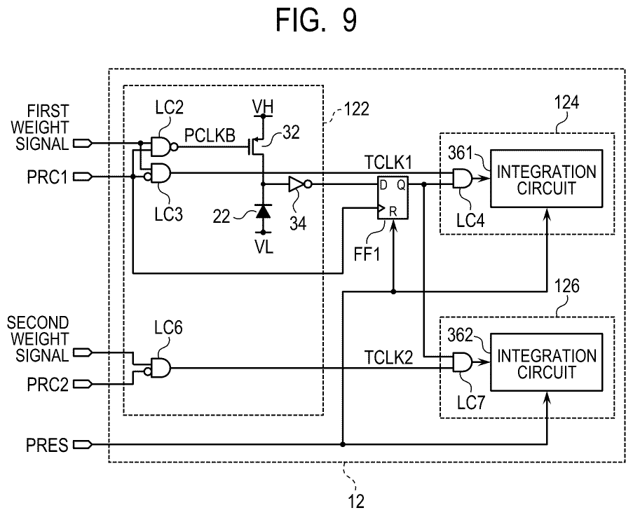

Next, a specific structure of the pixel 12 in the photoelectric conversion device according to the present embodiment will be described with reference to FIG. 9. FIG. 9 is a circuit diagram illustrating a configuration example of the pixel 12 in the photoelectric conversion device according to the present embodiment.

As illustrated in FIG. 9, the pixel 12 according to the present embodiment includes a photoelectric conversion element 22, a quenching element 32, a waveform shaping circuit 34, a NAND circuit LC2, AND circuits LC3, LC4, LC6, and LC7, a flip-flop circuit FF1, and integration circuits 361 and 362. Among them, the photoelectric conversion element 22, the quenching element 32, the waveform shaping circuit 34, the NAND circuit LC2, and the AND circuits LC3 and LC6 correspond to the light receiving unit 122. The flip-flop circuit FF1, the AND circuit LC4, and the integration circuit 361 correspond to the first integration unit 124, and the flip-flop circuit FF1, the AND circuit LC7, and the integration circuit 362 correspond to the second integration unit 126. In FIG. 9, for simplification of the drawing, the flip-flop circuit FF1 is not included in the constituent elements of the first integration unit 124 and the second integration unit 126.

The first weight signal is input to one input node of the NAND circuit LC2 and one input node of the AND circuit LC3. The control signal PRC1 is input to the other input terminal of the NAND circuit LC2 and a clock input terminal of the flip-flop circuit FF1. The inverted signal of the control signal PRC1 is input to the other input node of the AND circuit LC3. The second weight signal is input to one input node of the AND circuit LC6. The inverted signal of the control signal PRC2 is input to the other input node of the AND circuit LC6. A control signal PRES is input to reset terminals of the flip-flop circuit FF1, the integration circuit 361, and the integration circuit 362. The control signal PRES is a control signal output from the vertical scanning circuit unit 40 or the control pulse generation unit 90.

In the circuit of FIG. 9, the quenching element 32 is formed of a p-channel MOS transistor. The source of the p-channel MOS transistor is connected to the node of the voltage VH. The drain of the p-channel MOS transistor is connected to the cathode of the photoelectric conversion element 22 and the input node of the waveform shaping circuit 34. The gate of the p-channel MOS transistor is connected to an output node of the NAND circuit LC2. The output signal of the NAND circuit LC2 input to the gate of the p-channel MOS transistor is the signal PCLKB. The anode of the photoelectric conversion element 22 is connected to the node of the voltage VL.

The flip-flop circuit FF1 is a D-type flip-flop circuit having an input terminal D, an output terminal Q, a reset terminal R, and a clock input terminal. The output node of the waveform shaping circuit 34 is connected to the input terminal D of the flip-flop circuit FF1. The output terminal Q of the flip-flop circuit FF1 and an output node of the AND circuit LC3 are connected to input nodes of the AND circuit LC4. The output signal of the AND circuit LC3 is a signal TCLK1. An output terminal Q of the flip-flop circuit FF1 and an output node of the AND circuit LC6 are connected to input nodes of the AND circuit LC7. The output signal of the AND circuit LC6 is a signal TCLK2. An output node of the AND circuit LC4 is connected to the integration circuit 361. An output node of the AND circuit LC7 is connected to the integration circuit 362.

As described above, the unit exposure period (main frame period) in the photoelectric conversion device according to the present embodiment includes a plurality of sub-exposure periods (subframe periods). The control signal PRC1 is a pulse signal that transitions to high-level at the start of each of the plurality of subframe periods, and after transitioning to low-level, maintains low-level until the end of the subframe period. The control signal PRES is a pulse signal that transitions to high-level at the start of the main frame, and after transitioning to low-level, maintains low-level until the end of the main frame period. The control signal PRC2 will be described later.

The NAND circuit LC2 outputs a low-level signal when both the control signal PRC1 and the first weight signal are at high-level and outputs a high-level signal otherwise. Here, the signal PCLKB which is the output signal of the NAND circuit LC2 corresponds to the signal PCLKB described in the operation example of FIG. 6B to FIG. 6D. That is, when the signal PCLKB becomes low-level, the p-channel MOS transistor constituting the quenching element 32 is turned on, and the recharge operation of the photoelectric conversion element 22 is executed. That is, in a period in which the asserted period of the control signal PRC1 overlaps with the asserted period of the first weight signal, the recharge operation of the photoelectric conversion element 22 is performed. In this sense, the control signal PRC1 may be said to be a recharge signal for controlling the recharge operation of the quenching element 32 together with the first weight signal. The NAND circuit LC2 is a logic circuit that performs a recharge operation of the photoelectric conversion element 22 in a period in which the first weight signal and the control signal PRC1 (inverted signal of the first control signal) are asserted. The recharge operation of the photoelectric conversion element 22 is performed only once in each subframe period.

The output signal of the waveform shaping circuit 34 is input to the input terminal D of the flip-flop circuit FF1. The control signal PRC1 is input to the clock input terminal of the flip-flop circuit FF1. The control signal PRES is input to the reset terminal R of the flip-flop circuit FF1. The output signal of the flip-flop circuit FF1 becomes low-level in response to the rise of the control signal PRES. Further, the output signal of the flip-flop circuit FF1 becomes the same level as the input signal in response to the rise of the control signal PRC1 input to the clock input terminal.

The AND circuit LC3 is a logic circuit that outputs the first weight signal to the first integration unit 124 during the asserted period of the inverted signal (first control signal) of the control signal PRC1. The AND circuit LC4 is a logic circuit that outputs the first weight signal from the AND circuit LC3 to the integration circuit 361 during the asserted period of the output signal of the flip-flop circuit FF1. The AND circuit LC4 generates a pulse signal which is a result of a logical conjunction operation of the output signal (signal TCLK1) of the AND circuit LC3 and the output signal of the flip-flop circuit FF1 and outputs the pulse signal to the integration circuit 361. The integration circuit 361 integrates the pulse signal output from the AND circuit LC4 and holds the integration value (first integration value). A control signal PRES is input to the integration circuit 361. The integration value of the integration circuit 361 is initialized to an initial value in response to the high-level control signal PRES.

The AND circuit LC6 is a logic circuit that outputs the second weight signal to the second integration unit 126 during the asserted period of the inverted signal (second control signal) of the control signal PRC2. The AND circuit LC7 is a logic circuit that outputs the second weight signal from the AND circuit LC6 to the integration circuit 362 during the asserted period of the output signal of the flip-flop circuit FF1. The AND circuit LC7 generates a pulse signal which is a result of a logical conjunction operation of the output signal (signal TCLK2) of the AND circuit LC6 and the output signal of the flip-flop circuit FF1 and outputs the pulse signal to the integration circuit 362. The integration circuit 362 integrates the pulse signal output from the AND circuit LC7 and holds the integration value (second integration value). A control signal PRES is input to the integration circuit 362. The integration value of the integration circuit 362 is initialized to an initial value in response to the high-level control signal PRES.

In the pixel 12 of the present embodiment, the output signal of the waveform shaping circuit 34 becomes high-level when a photon enters the photoelectric conversion element 22. In addition to the transition of the output signal of the waveform shaping circuit 34 to high-level, the output signal of the flip-flop circuit FF1 becomes high-level by the transition of the control signal PRC1 to high-level. The state in which the output signal of the flip-flop circuit FF1 is at high-level continues until the next subframe period. While the output signal of the flip-flop circuit FF1 is at high-level, the output of the AND circuit LC4 is changed from low-level to high-level every time the pulse signal of the first weight signal is changed from low-level to high-level (every time the signal TCLK1 is changed to high-level). Thus, the integration circuit 361 integrates the number of times the signal TCLK1 transitions from low-level to high-level after the output signal of the flip-flop circuit FF1 transitions to high-level.

That is, the signal of the integration circuit 361 generated when one photon is incident is weighted by the signal TCLK1. Thus, the integration circuit 361 may perform integration weighted with respect to the incidence of one photon. As described above, since the signal TCLK1 is generated based on weighting such that more integration is performed as the photon reception timing is earlier, the value of the integration circuit 361 (hereinafter, referred to as a first integration value) inside the first integration unit 124 becomes a value correlated with light that is visible to the human eye.

On the other hand, the AND circuit LC7 generates a pulse signal which is a result of a logical conjunction operation of the output signal (signal TCLK2) of the AND circuit LC6 and the output signal of the flip-flop circuit FF1 and outputs the pulse signal to the integration circuit 362. Since the signal TCLK2 is generated based on the weighting corresponding to the sine wave component or the cosine wave component as described above, the value of the integration circuit 362 (hereinafter, referred to as the second integration value) inside the second integration unit 126 becomes the pixel value of the time-domain correlation for calculating the optical flow. The bit width of the integration circuit 361 and the bit width of the integration circuit 362 may be the same or different.

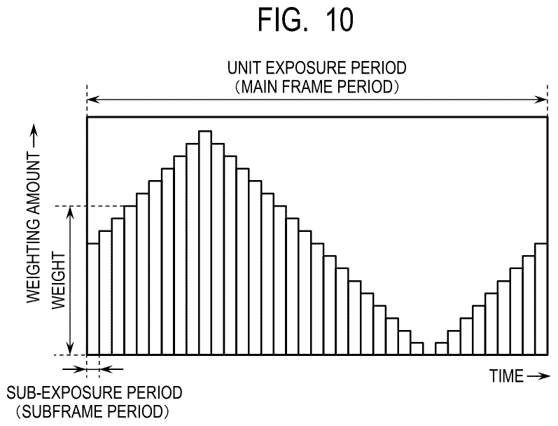

FIG. 10 is a diagram illustrating a relationship between the main frame period and the subframe period and an example of a temporal change in a weighting amount. In FIG. 10, the horizontal axis indicates time, and the vertical axis indicates a weighting amount set in each subframe period.

As illustrated in FIG. 10, a main frame period, which is a unit exposure period for generating one frame image, is divided into a plurality of sub-exposure periods (subframe periods). The second weight information input to the weight control unit 80 includes information on a weighting amount set in each subframe period. The weighting amount may be set based on a periodic function in which the time is a variable and the main frame period is one cycle. In other words, the periodic function has a different phase for each subframe period, and a different weighting amount is set for each phase.

The periodic function used for setting the weighting amount is not particularly limited, but may be, for example, a sine function. By performing weighting by a weighting amount based on a sine function, a signal corresponding to Expression (17) may be generated. The periodic function used for setting the weighting amount may be a cosine function. By performing weighting by the weighting amount based on the cosine function, a signal corresponding to Expression (16) may be generated. Note that one subframe period may be further divided into a plurality of microframe periods.

The weight control unit 80 sets the second weighting amount corresponding to each subframe period based on the relationship between the phase and the weighting amount in the periodic function used for setting the weighting amount. Thus, the integration circuit 362 can generate the signal TCLK2 corresponding to the weighting of each subframe period, and time-domain correlation imaging may be performed.

The first weighting amount set based on the first weighting information may be the same for each subframe period. Thinning processing is performed on the first weight signal set based on the first weighting amount in accordance with the incident timing of the photon. The thinning process according to the incident timing of the photon will be described later.

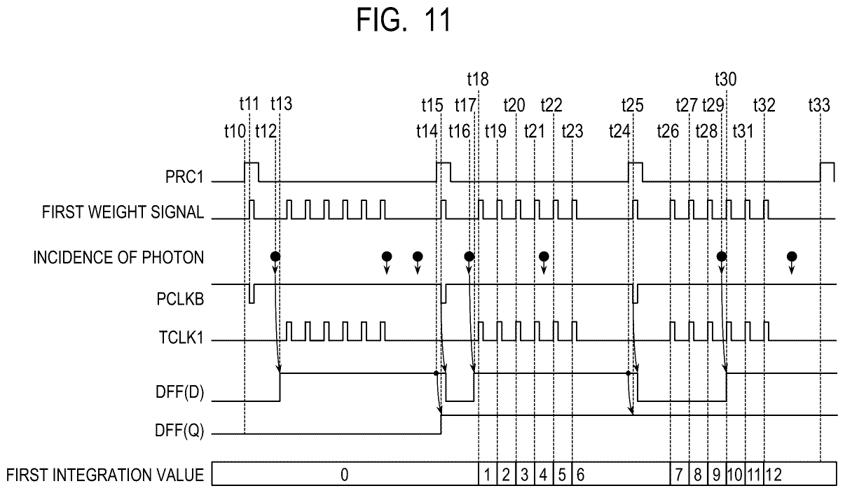

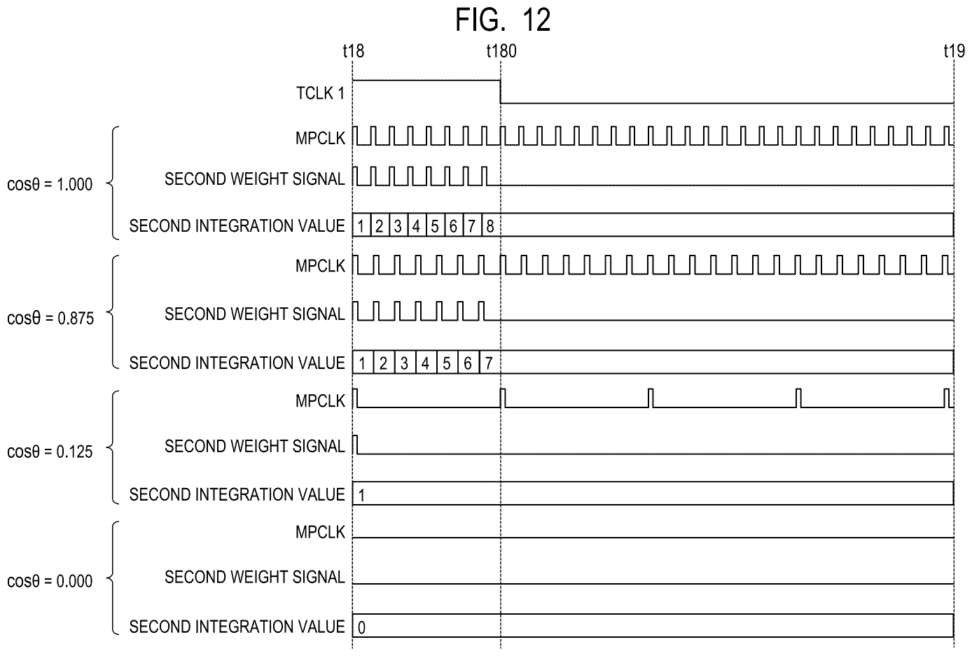

Next, the operation of the pixel 12 in the photoelectric conversion device according to the present embodiment will be described more specifically with reference to FIG. 11 to FIG. 13. FIG. 11 to FIG. 13 are timing charts illustrating the operation of the pixel 12 in the photoelectric conversion device according to the present embodiment.

FIG. 11 is a timing chart illustrating the integration operation of the first integration unit 124 (integration circuit 361). FIG. 11 illustrates the waveforms of the control signal PRC1, the first weight signal, the signals PCLKB and TCLK1, the input signal DFF(D) of the flip-flop circuit FF1, and the output signal DFF(Q) of the flip-flop circuit FF1, the timing of photon incidence, and the first integration value. FIG. 12 illustrates the waveforms of the signal TCLK1, the multiplied clock signal MPCLK, and the second weight signal, and the second integration value. The multiplied clock signal MPCLK, the second weight signal, and the second integration value indicate the cases where the values of the periodic function (cosine function) used for weighting are 1.000, 0.875, 0.125, and 0.000, respectively.

First, at time t10, the vertical scanning circuit unit 40 or the control pulse generation unit 90 sets the control signal PRC1 to asserted state (controls the control signal PRC1 from low-level to high-level). As a result, the first subframe period of the main frame period is started. At this time, the first weight signal is at low-level, and the signal PCLKB, which is the output signal of the NAND circuit LC2, is at high-level. At the time t10, the flip-flop circuit FF1 and the integration circuit 361 are in a reset state, that is, the input terminal D and the output terminal Q of the flip-flop circuit FF1 are at low-level, and the integration value (first integration value) of the integration circuit 361 is zero.

At the subsequent time t11, the first weight signal is set to asserted state under the control of the weight control unit 80. As a result, the signal PCLKB transitions from high-level to low-level, the p-channel MOS transistor constituting the quenching element 32 is turned on, and the recharge operation of the photoelectric conversion element 22 is executed. This recharge operation is performed only once at the start of each subframe period.

At the subsequent time t12, it is assumed that a photon is incident on the photoelectric conversion element 22 for the first time in this subframe period. Then, an avalanche multiplication current flows using the electron-hole pair generated in the photoelectric conversion element 22 as seeds, and the potential of the input node of the waveform shaping circuit 34 decreases. At the subsequent time t13, when the potential of the input node of the waveform shaping circuit 34 falls below the determination threshold value, the output node of the waveform shaping circuit 34 transitions from low-level to high-level, and the input terminal D of the flip-flop circuit FF1 also transitions to high-level. Since the photoelectric conversion element 22 is not recharged during a period from time t13 to time t14 when the control signal PRC1 is set to asserted state next, the signal level of the input terminal D of the flip-flop circuit FF1 in this period does not change regardless of whether or not a photon is incident. After the time t12, the first weight signal is set to asserted state the number of times according to the first weight information under the control of the weight control unit 80, but the output terminal Q of the flip-flop circuit FF1 is at low-level, and the integration operation in the integration circuit 361 is not performed.

When no photon is incident during the subframe period from the time t10 to the time t14, the input terminal D of the flip-flop circuit FF1 at the time t14 is at low-level, and the output terminal Q of the flip-flop circuit FF1 at the time t14 also remains at low-level. Therefore, the state at the time t14 becomes the same as that at the time t10, and the same operation as that from the time t10 to the time t14 is repeated in the next subframe period.

At the subsequent time t14, the vertical scanning circuit unit 40 or the control pulse generation unit 90 sets the control signal PRC1 to asserted state. As a result, the next subframe period is started. At this time, since the control signal PRC1 is also input to the clock input terminal of the flip-flop circuit FF1, the signal level of the output terminal Q of the flip-flop circuit FF1 transitions from low-level to high-level with the rise of the control signal PRC1 as a trigger.

At the subsequent time t15, the first weight signal is set to asserted state under the control of the weight control unit 80. As a result, the signal PCLKB transitions from high-level to low-level, the p-channel MOS transistor constituting the quenching circuit is turned on, and the recharge operation of the photoelectric conversion element 22 is executed. When the photoelectric conversion element 22 is recharged, the input node of the waveform shaping circuit 34 becomes high-level, the output node of the waveform shaping circuit 34 transitions from high-level to low-level, and the input terminal D of the flip-flop circuit FF1 also becomes low-level.

At the subsequent time t16, it is assumed that a photon is incident on the photoelectric conversion element 22 for the first time in this subframe period. Then, an avalanche multiplication current flows using the electron-hole pair generated in the photoelectric conversion element 22 as seeds, and the potential of the input node of the waveform shaping circuit 34 decreases. At the subsequent time t17, when the potential of the input node of the waveform shaping circuit 34 becomes lower than the determination threshold value, the output node of the waveform shaping circuit 34 transitions from low-level to high-level, and the input terminal D of the flip-flop circuit FF1 also becomes high-level. Since the photoelectric conversion element 22 is not recharged during the period from the time t17 to time t24 when the control signal PRC1 next transitions to high-level, the signal level of the input terminal D of the flip-flop circuit FF1 in this period does not change regardless of the presence or absence of photon incidence.

At the subsequent times t18, t19, t20, t21, t22, and t23, the first weight signal is set to asserted state under the control of the weight control unit 80. Since the control signal PRC1 is at low-level in the period from the time t18 to the time t23, the signal TCLK1 which is the output signal of the AND circuit LC3 has the same waveform as that of the first weight signal. In the period from the time t18 to the time t23, since the signal level of the output terminal Q of the flip-flop circuit FF1 is at high-level, the signal TCLK1 is directly input to the integration circuit 361 as the output signal of the AND circuit LC4. The integration circuit 361 integrates the number of pulse signals input from the AND circuit LC4. As a result, the integration value (first integration value) of the integration circuit 361 after receiving the sixth pulse rising at the time t23 becomes six.

At the subsequent time t24, the vertical scanning circuit unit 40 or the control pulse generation unit 90 sets the control signal PRC1 to asserted state. As a result, the next subframe period is started. At this time, although the control signal PRC1 is also input to the clock input terminal of the flip-flop circuit FF1, since the signal level of the output terminal Q of the flip-flop circuit FF1 is at the same high-level as the signal level of the input terminal D, the signal level of the output terminal Q does not change.

At the subsequent time t25, the first weight signal is set to asserted state under the control of the weight control unit 80. As a result, the signal PCLKB transitions from high-level to low-level, the p-channel MOS transistor constituting the quenching element 32 is turned on, and the recharge operation of the photoelectric conversion element 22 is executed. When the photoelectric conversion element 22 is recharged, the input node of the waveform shaping circuit 34 becomes high-level, the output node of the waveform shaping circuit 34 transitions from high-level to low-level, and the input terminal D of the flip-flop circuit FF1 also becomes low-level.

At the subsequent times t26, t27, t28, t30, t31, and t32, the first weight signal is set to asserted state under the control of the weight control unit 80. Since the control signal PRC1 is at low-level in the period from the time t26 to the time t32, the signal TCLK1 which is the output signal of the AND circuit LC3 has the same waveform as that of the first weight signal. In the period from the time t26 to the time t32, since the signal level of the output terminal Q of the flip-flop circuit FF1 is at high-level, the signal TCLK1 is directly input to the integration circuit 361 as the output signal of the AND circuit LC4. The integration circuit 361 integrates the number of pulse signals input from the AND circuit LC4. As a result, the integration value (first integration value) of the integration circuit 361 after receiving the sixth pulse rising at the time t32 becomes twelve.

At time t29 between the time t26 and the time t32, it is assumed that a photon is incident on the photoelectric conversion element 22 for the first time in this subframe period. Then, an avalanche multiplication current flows using the electron-hole pair generated in the photoelectric conversion element 22 as seeds, and the potential of the input node of the waveform shaping circuit 34 decreases. At the subsequent time t30, when the potential of the input node of the waveform shaping circuit 34 becomes lower than the determination threshold value, the output node of the waveform shaping circuit 34 transitions from low-level to high-level, and the input terminal D of the flip-flop circuit FF1 also becomes high-level. However, since the output terminal Q of the flip-flop circuit FF1 is maintained at high-level in this subframe period, the integration circuit 361 integrates all the pulse signals of the signal TCLK1 input during this subframe period regardless of the timing of photon incidence.

When no photon is incident in the subframe period from the time t14 to the time t24, the input terminal D of the flip-flop circuit FF1 at time t24 is at low-level, and the output terminal Q of the flip-flop circuit FF1 transitions to low-level at the time t24. Therefore, the state at the time t24 becomes the same as the state at the time t10, and the same operation as that from the time t10 to the time t14 is performed in the next subframe period.

At the subsequent time t33, the vertical scanning circuit unit 40 or the control pulse generation unit 90 sets the control signal PRC1 to asserted state. As a result, the next subframe period is started. After that, the same operation is repeatedly performed for each subframe period. That is, the integration circuit 361 integrates the number of pulse signals superimposed on the signal TCLK1 in the next subframe period in response to detection of a photon in the immediately preceding frame period. The first integration value generated in this manner is a value correlated with light that is visible to the human eye as described above.

Next, the integration operation in the second integration unit 126 will be described with reference to FIG. 12, taking the operation in the period from the time t18 to the time t19 as an example. FIG. 12 is a timing chart illustrating the integration operation of the second integration unit 126 (integration circuit 362) in the period from the time t18 to the time t19 in FIG. 11. As described above, the integration value (second integration value) of the integration circuit 362 is a value of the time-domain correlation for calculating the optical flow.

Here, as a premise, a method of expressing a decimal number of a value of a trigonometric function such as a sine function and a cosine function by a digital circuit in order to calculate a value of a time-domain correlation based on an incident photon will be described. The value of the trigonometric function varies between −1.0 and 1.0. On the other hand, in order to improve the accuracy of the optical flow, it is important to increase the number of decimal digits. In view of the above, in order to express a value of a trigonometric function on a digital circuit, it is assumed here that an offset of one is given as an example and the value is expressed by a fixed decimal number of arbitrary bits. For example, in the case of taking an integer of one bit and a fixed decimal number of three bits, 1000 in binary number (8 in decimal number) may be interpreted as 1.0. Similarly, 0111 in binary number (7 in decimal number) may be interpreted as 0.875, 0110 in binary number (6 in decimal number) may be interpreted as 0.75, and 0101 in binary number (5 in decimal number) may be interpreted as 0.625.

FIG. 12 illustrates the multiplied clock signal MPCLK, the second weight signal, and the second integration value when the value of the cosine function is 1.000, 0.875, 0.125, and 0.000, respectively. A period in which the weight control unit 80 sets the second weight signal based on the multiplied clock signal MPCLK and the first weight signal to asserted state is a period from time t18 to time t180. When the weighting amount corresponding to the value of the cosine function is expressed by eight gradations, the second weight signal may include, for example, eight pulses when the value of the cosine function is 1.000, seven pulses when the value of the cosine function is 0.875, one pulse when the value of the cosine function is 0.125, and 0 pulses when the value of the cosine function is 0.000. The multiplied clock signal MPCLK may be generated by appropriately changing the frequency of the clock signal CLK in accordance with the second weight information in the time-domain correlation pulse generation unit. That is, the period of the clock signal CLK may be changed so that the number of pulses rising during one asserted period of the signal TCLK1 becomes a predetermined number according to the second weight information. Alternatively, after the frequency of the clock signal CLK is controlled to include the maximum number of pulses corresponding to the second weight information during one asserted period of the signal TCLK1, the number of pulses rising during the asserted period of the signal TCLK1 may be controlled by thinning out a part of the pulses.

The AND circuit LC6 generates the signal TCLK2 in accordance with the second weight signal asserted in the period from the time t18 to the time t180 and the control signal PRC2. The integration circuit 362 integrates the number of pulse signals output from the AND circuit LC7 in accordance with the output signal of the flip-flop circuit FF1 and the signal TCLK2. For example, when the value of the cosine function is 1.000 (cos θ=1.000), the number of pulse signals input to the integration circuit 362 in the period from the time t18 to the time t180 is 8, and the integration value (second integration value) of the integration circuit 362 is 8. Similarly, the integration values (second integration values) of the integration circuit 362 in the case of cos θ=0.875, the case of cos θ=0.125, and the case of cos θ=0.000 is 7, 1, and 0, respectively.

The configuration of the weight control unit 80 and the method of generating the first weight signal and the second weight signal illustrated in FIG. 7 are merely examples. The first weight signal and the second weight signal may be pulses that finally obtain a second integration value having a correlation with the second weight with respect to the first integration value. For example, when the frequency of the signal TCLK2 becomes high and there is a concern about power consumption or operation speed, the second weight signal may be generated such that the asserted number of the signal TCLK2 according to the second weight information is obtained irrespective of the asserted period of the signal TCLK1. The asserted period and the negated period of the first weight signal and the second weight signal may also be appropriately changed.

As described above, in the present embodiment, in response to detection of a photon in the previous subframe period, weighting may be given by the number of pulse signals of the signals TCLK1 and TCLK2 in the next subframe period. Although the offset value and the amplitude of the weighting are assumed to be one and the fixed decimal number is assumed to be three bits here, they may be appropriately changed.

In the present embodiment, a method of integrating the number of weighted signals TCLK1 and TCLK2 has been described, but the present embodiment is not limited to this method as long as the method is an imaging method using an avalanche photodiode and a time-domain correlation image is obtained. Further, a configuration may be adopted in which an integration unit different from the first integration unit 124 and the second integration unit 126 is added, and pulse signals based on a third weighting different from the first weighting and the second weighting are further integrated. In FIG. 8 and FIG. 9, the first weight signal and the second weight signal are input to the light receiving unit 122, but the first weight signal and the second weight signal may be input to the first integration unit 124 and the second integration unit 126, respectively, to realize the same integration function. The relationship between the value of the solution of the trigonometric function and the number of pulses is not limited to the above example, and the bit widths of the sine function and the cosine function and the number of subframe periods may be arbitrarily changed.

Next, a method of realizing time-domain correlation imaging while suppressing an increase in the circuit scale of the second integration unit by controlling the drive timing of the control signals PRC1 and PRC2 will be described with reference to FIG. 13. FIG. 13 is a timing chart illustrating an operation of the pixel 12 in the photoelectric conversion device according to the present embodiment.

FIG. 13 illustrates the operation in the main frame period MF1 starting at time t30 and ending at time t34. FIG. 13 illustrates the waveform of the control signal PRC1 and the subframe periods in the first integration unit, and the waveform of the control signal PRC2 and the subframe periods in the second integration unit. The waveform of the control signal PRC2 and the subframe periods in the second integration unit illustrate two types of operations (control pattern 1 and control pattern 2) having different control patterns. Assuming that the frame rate is 30 fps, the length of the period from the time t30 to the time t34 is 33.3 ms.

Here, it is assumed that the main frame period MF1 is divided into 2048 subframe periods SF1 to SF2048. In FIG. 13, time t31 is the start time of the second subframe period SF2, time t32 is the start time of the fifth subframe period SF5, and time t33 is the start time of the ninth subframe period SF9. As described above, the control signal PRC1 is set to asserted state only once during the subframe period. Focusing on the subframe period SF1, the control signal PRC1 is set to asserted state once between the time t30 and the time t31.

For example, in a case where the maximum value of the first integration value in one subframe period is 8, the maximum value of the first integration value in one main-frame period is 16384 (=8×2048). In order to enable integration up to 16384 in the first integration unit 124, an integration circuit 361 having a bit width of 14 bits or more is required.

On the other hand, in a case where the value of the trigonometric function is expressed by an integer of 1 bit and a fixed decimal number of 3 bits as described above, the second integration value further has a gradation of 8 times, and the maximum value of the second integration value in one subframe period may be 64. However, in a case where the time-domain correlation values of one cycle in one main frame period are integrated, 64, which is the maximum value, is not integrated in all subframe periods, and the integration value per subframe period is an average value of a sine function or a cosine function at the maximum.

For example, when the offsets and the amplitudes of the sine function and the cosine function are 1, the average value is 1, and the average value of the integration values in one main frame period may be considered to be 32. Therefore, the maximum value of the second integration value in one main frame period is 65536 (=32×2048). In order to enable integration up to 65536 in the second integration unit 126, an integration circuit 362 having a bit width of 16 bits or more is required. An increase in the bit widths of the integration circuits 361 and 362 leads to an increase in the circuit scale of the pixel 12, which leads to an increase in the size of the photoelectric conversion device. If the bit widths of the integration circuits 361 and 362 are reduced, an increase in the circuit scale may be suppressed, but the resolution is reduced.

Control pattern 1 and control pattern 2 illustrated in FIG. 13 are driving examples for reducing the maximum value of the second integration value in one main frame period.

The control pattern 1 is a driving example in which the subframe period of the second integration unit 126 is executed once every time the subframe period of the first integration unit 124 is executed eight times. In this case, as illustrated in, e.g., FIG. 13, the control signal PRC2 is controlled in the same manner as the control signal PRC1 in the period from the time t30 to the time t31, and is controlled to high-level in the period from the time t31 to the time t33.

Here, an inverted signal of the control signal PRC1 is referred to as a first control signal, and an inverted signal of the control signal PRC2 is referred to as a second control signal. In this case, the first weight signal is output to the first integration unit 124 during the asserted period in which the first control signal is at high-level, and the second weight signal is output to the second integration unit 126 during the asserted period in which the second control signal is at high-level. That is, the integration operation in the first integration unit 124 is performed during the asserted period of the first control signal, and the integration operation in the second integration unit 126 is performed during the asserted period of the second control signal. Therefore, by controlling the control signals PRC1 and PRC2 as described above, the number of asserted periods of the second control signal in the main frame period MF1 becomes smaller than the number of asserted periods of the first control signal in the main frame period MF1.

As a result, in the period from the time t30 to the time t33, the first integration unit 124 executes eight subframe periods SF1 to SF8, while the second integration unit 126 executes one subframe period SF1. By repeatedly executing the same operation as the period from the time t30 to the time t33 in the subsequent period from the time t33 to the time t34, it is possible to reduce the number of subframe periods of the second integration unit 126 executed during the main frame period MF1 to one eighth. Thus, the maximum value of the second integration value in one main frame period is 8192 (=65536/8) in consideration of the average value of the sine function and the cosine function.

The number of reductions in the subframe period in the second integration unit 126 is not particularly limited but may be set according to the number of bits used to represent a fixed decimal number of the periodic function, for example. For example, in a case where the fixed decimal number is represented by three bits as in the above-described example, by reducing the number of subframe periods of the second integration unit 126 to one eighth, the bit width of the integration circuit 362 may be reduced by an amount corresponding to the number of bits of the fixed decimal number.

The control pattern 2 is a driving example in which the subframe period of the second integration unit 126 is executed once every time the subframe period of the first integration unit 124 is executed four times. In this case, as illustrated in, e.g., FIG. 13, the control signal PRC2 is controlled in the same manner as the control signal PRC1 in the period from the time t30 to the time t31, and is controlled to high-level in the period from the time t31 to the time t32. Also in this case, the number of asserted periods of the second control signal in the main frame period MF1 is smaller than the number of asserted periods of the first control signal in the main frame period MF1.

As a result, in the period from the time t30 to the time t32, the first integration unit 124 executes four subframe periods SF1 to SF4, while the second integration unit 126 executes one subframe period SF1. By repeatedly executing the same operation as the period from the time t30 to the time t32 in the subsequent period from the time t32 to the time t34, it is possible to reduce the number of subframe periods of the second integration unit 126 executed during the main frame period MF1 to one fourth. Thus, the maximum value of the second integration value in one main frame period is 16384 (=65536/4) in consideration of the average value of the sine function and the cosine function.

In addition to the reduction of the subframe period in the second integration unit 126, the second weight signal may be changed. For example, when the maximum value of the integration value in one subframe period of the second integration unit 126 is 64, the second weight signal is changed so that the maximum value of the integration value becomes 32. By applying this control to the control pattern 2, it is possible to reduce the maximum value of the second integration value in one main frame period to the same level as in the case of the control pattern 1 while reducing the period in which imaging is not performed in one main frame period as compared with the case of the control pattern 1.

Note that the control pattern 1 and the control pattern 2 are examples, and the control method of the photoelectric conversion device according to the present embodiment is not limited thereto. For example, the maximum value of the second integration value does not necessarily need to be controlled to be smaller than the maximum value of the first integration value, and the maximum value of the second integration value may be controlled to be smaller, or the maximum value of the second integration value may be controlled to be larger. In addition, the asserted period and the negated period of the control signals PRC1 and PRC2 illustrated in FIG. 13 are not limited to these periods, and any control may be performed as long as the number of subframe periods in the first integration unit 124 and the number of subframe periods in the second integration unit 126 are different from each other. That is, the asserted timings of the control signals PRC1 and PRC2 may be separately controlled. In addition, it is not necessary to reduce the subframe period in the second integration unit 126, and the maximum value of the integration value in the subframe period in the second integration unit 126 may be different from the maximum value of the integration value in the subframe period in the first integration unit 124.

As described above, according to the photoelectric conversion device of the present embodiment, time-domain correlation imaging may be realized. Further, in the photoelectric conversion device of the present embodiment, since the APD is used as the photoelectric conversion element, it is possible to suitably perform time-domain correlation imaging in a low-luminance shooting scene. Further, in the photoelectric conversion device of the present embodiment, the control of the output of the signal from the light receiving unit to the first integration unit is performed using the first control signal, the control of the output of the signal from the light receiving unit to the second integration unit is performed using the second control signal, and the number of the asserted periods of the second control signal is set to be smaller than the number of the asserted periods of the first control signal. Therefore, according to the photoelectric conversion device of the present embodiment, time-domain correlation imaging may be realized while reducing the circuit scale of the pixel.

### Second Embodiment

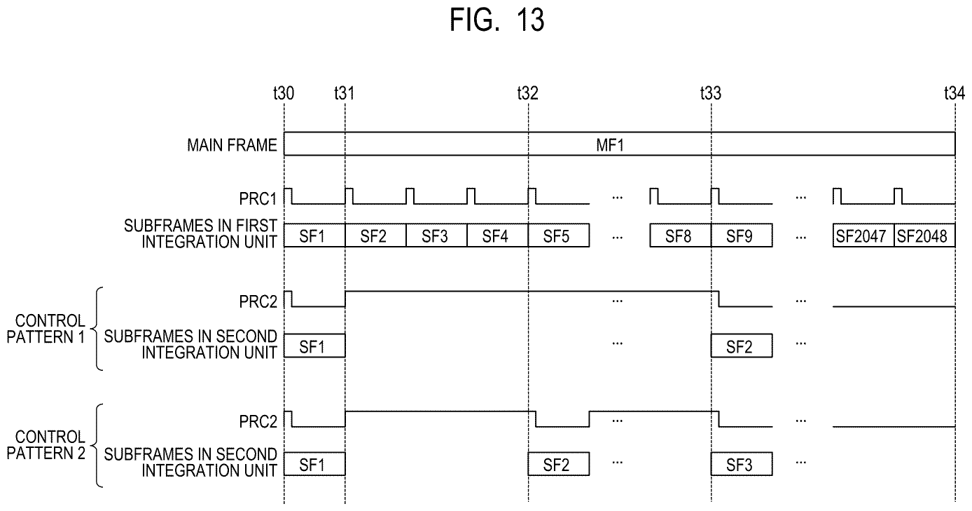

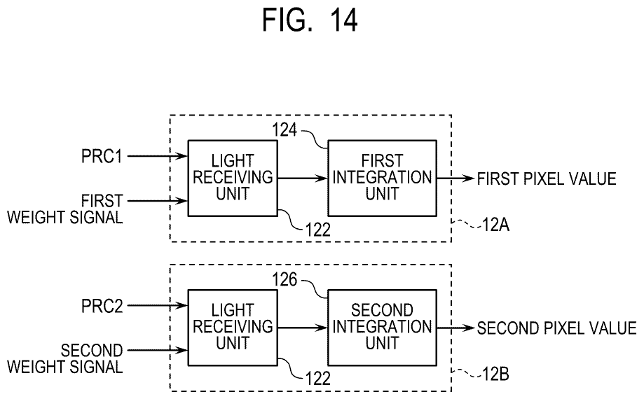

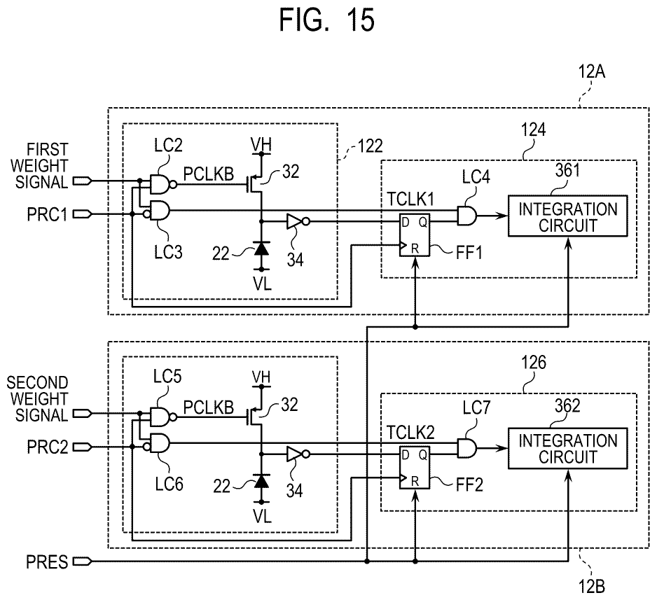

A photoelectric conversion device according to a second embodiment will be described with reference to FIG. 14 and FIG. 15. FIG. 14 is a functional block diagram illustrating a schematic configuration of pixels 12 in a photoelectric conversion device according to the present embodiment. FIG. 15 is a circuit diagram illustrating a configuration example of the pixels 12 in the photoelectric conversion device according to the present embodiment. The same components as those of the photoelectric conversion device according to the first embodiment are denoted by the same reference numerals, and description thereof will be omitted or simplified.

The photoelectric conversion device according to the present embodiment is the same as the photoelectric conversion device according to the first embodiment except that the configuration of the pixel 12 is different. In the present embodiment, differences between the photoelectric conversion device of the present embodiment and the photoelectric conversion device of the first embodiment will be mainly described, and description of similar points to those of the photoelectric conversion device of the first embodiment will be appropriately omitted.

In the pixel 12 of the photoelectric conversion device according to the first embodiment, as illustrated in FIG. 7, each of the plurality of pixels 12 configuring the pixel unit 10 includes a light receiving unit 122, a first integration unit 124, and a second integration unit 126. In contrast, in the photoelectric conversion device according to the present embodiment, as illustrated in FIG. 14, the plurality of pixels 12 configuring the pixel unit 10 include a pixel 12A including the light receiving unit 122 and the first integration unit 124, and a pixel 12B including the light receiving unit 122 and the second integration unit 126. The pixel 12A and the pixel 12B may be arranged adjacent to each other.

In the present embodiment, since each pixel 12 has only one of the first integration unit 124 and the second integration unit 126, the area of the pixel circuit may be reduced as compared with the pixel 12 having the first integration unit 124 and the second integration unit 126. Thus, the size of the photoelectric conversion device may be reduced.

As illustrated in, e.g., FIG. 15, the pixel 12A may include a photoelectric conversion element 22, a quenching element 32, a waveform shaping circuit 34, a flip-flop circuit FF1, a NAND circuit LC2, AND circuits LC3 and LC4, and an integration circuit 361. Among them, the photoelectric conversion element 22, the quenching element 32, the waveform shaping circuit 34, the NAND circuit LC2, and the AND circuit LC3 correspond to the light receiving unit 122, and the flip-flop circuit FF1, the AND circuit LC4, and the integration circuit 361 correspond to the first integration unit 124.

The first weight signal is input to one input node of the NAND circuit LC2 and one input node of the AND circuit LC3. The control signal PRC1 is input to the other input terminal of the NAND circuit LC2 and a clock input terminal of the flip-flop circuit FF1. The inverted signal of the control signal PRC1 is input to the other input node of the AND circuit LC3. The control signal PRES is input to reset terminals of the flip-flop circuit FF1 and the integration circuit 361.

A source of a p-channel MOS transistor constituting the quenching element 32 is connected to the node of the voltage VH. A drain of the p-channel MOS transistor is connected to a cathode of the photoelectric conversion element 22 and an input node of the waveform shaping circuit 34. A gate of the p-channel MOS transistor is connected to an output node of the NAND circuit LC2. An output signal of the NAND circuit LC2 input to the gate of the p-channel MOS transistor is the signal PCLKB. An anode of the photoelectric conversion element 22 is connected to the node of the voltage VL.

An output node of the waveform shaping circuit 34 is connected to an input terminal D of the flip-flop circuit FF1. An output terminal Q of the flip-flop circuit FF1 and an output node of the AND circuit LC3 are connected to input nodes of the AND circuit LC4. An output node of the AND circuit LC4 is connected to the integration circuit 361.

As illustrated in, e.g., FIG. 15, the pixel 12B may include a photoelectric conversion element 22, a quenching element 32, a waveform shaping circuit 34, a flip-flop circuit FF2, a NAND circuit LC5, AND circuits LC6 and LC7, and an integration circuit 362. Among them, the photoelectric conversion element 22, the quenching element 32, the waveform shaping circuit 34, the NAND circuit LC5, and the AND circuit LC6 correspond to the light receiving unit 122, and the flip-flop circuit FF2, the AND circuit LC7, and the integration circuit 362 correspond to the second integration unit 126.

The second weight signal is input to one input node of the NAND circuit LC5 and one input node of the AND circuit LC6. The control signal PRC2 is input to the other input terminal of the NAND circuit LC5 and a clock input terminal of the flip-flop circuit FF2. The inverted signal of the control signal PRC2 is input to the other input node of the AND circuit LC6. The control signal PRES is input to reset terminals of the flip-flop circuit FF2 and the integration circuit 362.

A source of a p-channel MOS transistor constituting the quenching element 32 is connected to the node of the voltage VH. A drain of the p-channel MOS transistor is connected to a cathode of the photoelectric conversion element 22 and an input node of the waveform shaping circuit 34. A gate of the p-channel MOS transistor is connected to an output node of the NAND circuit LC5. An output signal of the NAND circuit LC5 input to the gate of the p-channel MOS transistor is the signal PCLKB. An anode of the photoelectric conversion element 22 is connected to the node of the voltage VL.

The NAND circuit LC5 outputs a low-level signal when both the control signal PRC2 and the second weight signal are at high-level, and outputs a high-level signal otherwise. Here, the signal PCLKB which is the output signal of the NAND circuit LC5 corresponds to the signal PCLKB described in the operation examples of FIG. 6B to FIG. 6D. That is, when the signal PCLKB becomes low-level, the p-channel MOS transistor constituting the quenching element 32 is turned on, and the recharge operation of the photoelectric conversion element 22 is executed. That is, in a period in which the asserted period of the control signal PRC2 overlaps with the asserted period of the second weight signal, the recharge operation of the photoelectric conversion element 22 is performed. In this sense, the control signal PRC2 in the present embodiment is also a recharge signal for controlling the recharge operation of the quenching element 32 together with the second weight signal.

An output node of the waveform shaping circuit 34 is connected to an input terminal D of the flip-flop circuit FF2. An output terminal Q of the flip-flop circuit FF2 and an output node of the AND circuit LC6 are connected to an input node of the AND circuit LC7. An output node of the AND circuit LC7 is connected to the integration circuit 362.

The NAND circuit LC5 outputs a low-level signal when both the control signal PRC2 and the second weight signal are at high-level, and outputs a high-level signal otherwise. Here, the signal PCLKB which is the output signal of the NAND circuit LC5 corresponds to the signal PCLKB described in the operation examples of FIG. 6B to FIG. 6D. That is, when the signal PCLKB becomes low-level, the p-channel MOS transistor constituting the quenching element 32 of the pixel 12B is turned on, and the recharge operation of the photoelectric conversion element 22 of the pixel 12B is executed. The NAND circuit LC5 is a logic circuit that performs a recharge operation of the photoelectric conversion element 22 of the pixel 12B in a period in which the second weight signal and the control signal PRC2 (inverted signal of the second control signal) are asserted. The photoelectric conversion element 22 is recharged only once in each subframe period.

An output signal of the waveform shaping circuit 34 of the pixel 12B is input to an input terminal D of the flip-flop circuit FF2. The control signal PRC2 is input to a clock input terminal of the flip-flop circuit FF2. The control signal PRES is input to a reset terminal R of the flip-flop circuit FF2. The output signal of the flip-flop circuit FF2 becomes low-level in response to the rise of the control signal PRES. Further, the output signal of the flip-flop circuit FF2 becomes the same level as the input signal in response to the rise of the control signal PRC2 input to the clock input terminal.

The AND circuit LC7 is a logic circuit that outputs the second weight signal from the AND circuit LC6 to the integration circuit 362 during the asserted period of the output signal of the flip-flop circuit FF2. The AND circuit LC7 generates a pulse signal which is a result of a logical conjunction operation of the output signal (signal TCLK2) of the AND circuit LC6 and the output signal of the flip-flop circuit FF2 and outputs the pulse signal to the integration circuit 362.

In the present embodiment, the first integration value of the integration circuit 361 and the second integration value of the integration circuit 362 are generated by integrating pulse signals based on different photoelectric conversion elements 22. That is, the input to the AND circuit LC4 that outputs the pulse signal to the integration circuit 361 becomes the output signal of the flip-flop circuit FF1 that holds the output of the light receiving unit 122 of the pixel 12A. On the other hand, an input to the AND circuit LC7 that outputs a pulse signal to the integration circuit 362 is an output signal of the flip-flop circuit FF2 that holds the output of the light receiving unit 122 of the pixel 12B.

As described above, according to the photoelectric conversion device of the present embodiment, time-domain correlation imaging may be realized. Further, in the photoelectric conversion device of the present embodiment, since the APD is used as the photoelectric conversion element, it is possible to suitably perform time-domain correlation imaging in a low-luminance shooting scene. Further, in the photoelectric conversion device of the present embodiment, the control of the output of the signal from the light receiving unit to the first integration unit is performed using the first control signal, the control of the output of the signal from the light receiving unit to the second integration unit is performed using the second control signal, and the number of the asserted periods of the second control signal is set to be smaller than the number of the asserted periods of the first control signal. Therefore, according to the photoelectric conversion device of the present embodiment, time-domain correlation imaging may be realized while reducing the circuit scale of the pixel. Further, according to the photoelectric conversion device of the present embodiment, the area of the pixel circuit may be reduced as compared with the first embodiment, and the size of the photoelectric conversion device may be further reduced.

### Third Embodiment

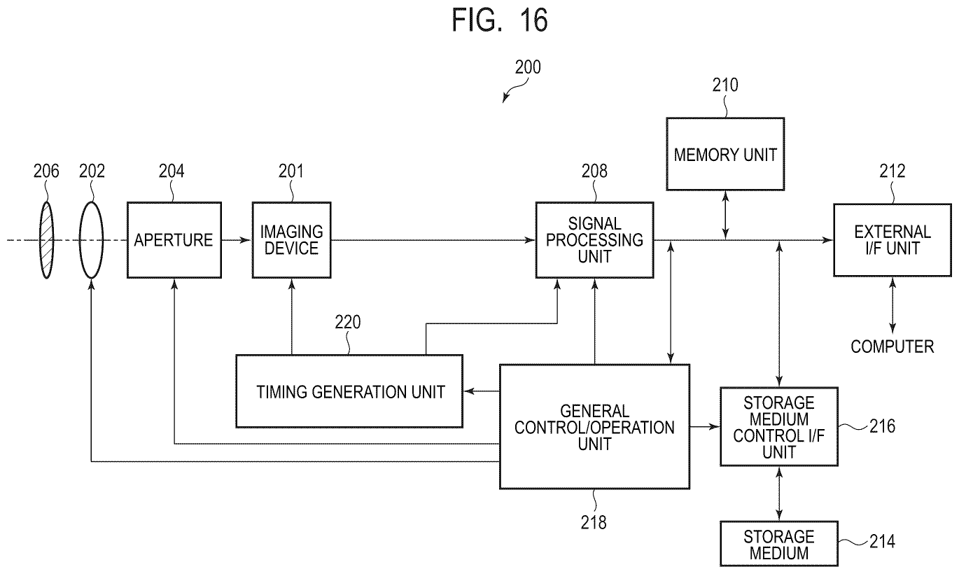

A photoelectric conversion system according to a third embodiment will be described with reference to FIG. 16. FIG. 16 is a block diagram illustrating a schematic configuration of a photoelectric conversion system according to the present embodiment.

The photoelectric conversion device 100 described in the first and second embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 16 exemplifies a block diagram of a digital still camera as one of these.

The photoelectric conversion system 200 illustrated in FIG. 16 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 constitute an optical system that focuses light onto the imaging device 201. The imaging device 201 is the photoelectric conversion device 100 described in the first or second embodiment and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer different from the semiconductor layer on which the photoelectric conversion unit of the imaging device 201 is formed. In addition, the signal processing unit 208 may be formed on the same semiconductor layer as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201 and outputs the processed image data. The signal processing unit 208 generates an image using the imaging signal.

As described above, according to the present embodiment, it is possible to realize a photoelectric conversion system to which the photoelectric conversion device 100 according to the first or second embodiment is applied.

### Fourth Embodiment

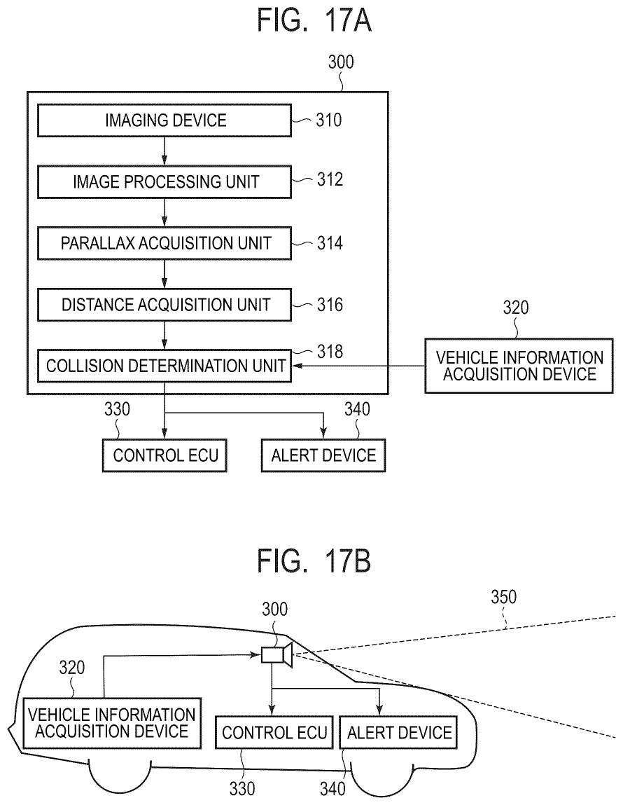

A photoelectric conversion system and a movable object according to a fourth embodiment will be described with reference to FIG. 17A and FIG. 17B. FIG. 17A is a diagram illustrating a configuration of a photoelectric conversion system according to the present embodiment. FIG. 17B is a diagram illustrating a configuration of a movable object according to the present embodiment.

FIG. 17A illustrates an example of a photoelectric conversion system related to an on-vehicle camera. The photoelectric conversion system 300 includes an imaging device 310. The imaging device 310 is the photoelectric conversion device 100 according to the first or second embodiment. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310.

Here, the photoelectric conversion system 300 may include an optical system (not illustrated) that guides light to the photoelectric conversion device 100, such as a lens, a shutter, and a mirror. A plurality of photoelectric conversion units substantially conjugate to the pupil of the optical system may be arranged in the pixels included in the photoelectric conversion device 100. For example, a plurality of photoelectric conversion units substantially conjugate to the pupil are arranged corresponding to one microlens. The plurality of photoelectric conversion units receives light beams transmitted through different positions of the pupil of the optical system, thereby outputting image data corresponding to light beams transmitted through different positions of the photoelectric conversion device 100. Then, the parallax acquisition unit 314 may calculate the parallax using the output image data.

The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information may be acquired using a time of flight (TOF) technique. The distance information acquisition unit may be realized by dedicatedly designed hardware or may be realized by a software module. Further, it may be realized by a field programmable gate array (FPGA), an application specific integrated circuit (ASIC), or the like, or may be realized by a combination of these.

The photoelectric conversion system 300 is connected to a vehicle information acquisition device 320 and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 17B illustrates the photoelectric conversion system in the case of capturing an image in front of the vehicle (imaging range 350). The vehicle information acquisition device 320 sends instructions to the photoelectric conversion system 300 or the imaging device 310. With such a configuration, the accuracy of distance measurement may be further improved.

Although an example in which control is performed so as not to collide with another vehicle has been described above, the present disclosure is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other movable objects (mobile devices), such as, for example, a ship, an aircraft, or an industrial robot. In addition, the present disclosure is not limited to the movable object and may be widely applied to equipment using object recognition, such as intelligent transport systems (ITS).

### Fifth Embodiment

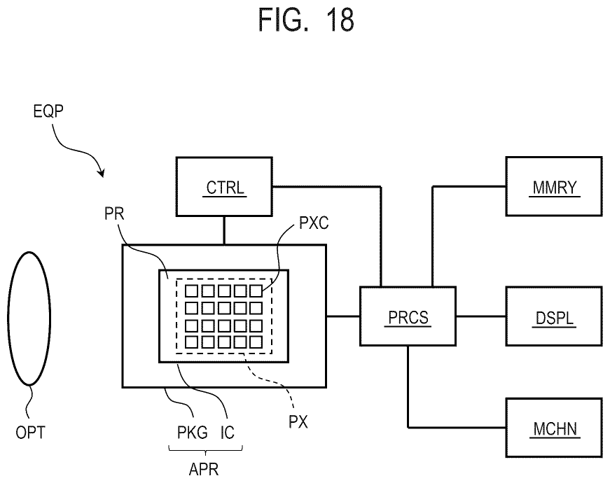

An equipment according to a fifth embodiment will be described with reference to FIG. 18. FIG. 18 is a block diagram illustrating a schematic configuration of an equipment according to the present embodiment.

FIG. 18 is a schematic diagram illustrating an equipment EQP including a photoelectric conversion device APR. The photoelectric conversion device APR has the function of the photoelectric conversion device 100 according to the first or second embodiment. All or part of the photoelectric conversion device APR is a semiconductor device IC. The photoelectric conversion device APR of the present example may be used as, for example, an image sensor, an AF (Auto Focus) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be arranged in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be a column circuit corresponding to a pixel column of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (e.g., a through silicon via (TSV)), an inter-chip wiring by direct bonding of a conductor such as copper, a connection by a micro bump between the chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC.

The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. In addition, the processing device PRCS may acquire the optical flow using the signal output by the photoelectric conversion device 100 of each of the above-described embodiments. That is, the processing device PRCS may generate three images of an image based on a sine wave component, an image based on a cosine wave component, and a normal image, and acquire an optical flow from the three images.

The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR. The mechanical device MCHN may be controlled based on a signal output from the photoelectric conversion device APR.

The equipment EQP illustrated in FIG. 18 may be an electronic device such as an information terminal (for example, a smartphone or a wearable terminal) having a photographing function or a camera (for example, an interchangeable lens camera, a compact camera, a video camera, and a monitoring camera.). The mechanical device MCHN in the camera may drive components of the optical device OPT for zooming, focusing, and shutter operation. Alternatively, the mechanical device MCHN in the camera may move the photoelectric conversion device APR for the vibration isolation operation.

In addition, the equipment EQP may be a transportation device (movable object) such as a vehicle, a ship, or an aircraft. The mechanical device MCHN in the transportation device may be used as a mobile device. The equipment EQP as a transportation device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a moving device based on information obtained by the photoelectric conversion device APR.

The equipment EQP may be a medical device such as an endoscope or a CT scanner, a measurement device such as a distance measurement sensor, an analysis device such as an electron microscope, an office device such as a copying machine, or an industrial device such as a robot.

According to the photoelectric conversion device 100 of the above-described embodiment, it is possible to obtain excellent pixel characteristics. Therefore, the value of the photoelectric conversion device may be increased. Here, increasing the value corresponds to at least one of adding a function, improving performance, improving characteristics, improving reliability, improving manufacturing yield, reducing environmental load, reducing cost, reducing size, and reducing weight.

Therefore, when the photoelectric conversion device 100 of the above-described embodiment is used in the equipment EQP, the value of the equipment EQP may also be improved. For example, excellent performance may be obtained when the photoelectric conversion device 100 is mounted on a transportation device and photographing of the outside of the transportation device or measurement of an external environment is performed. Therefore, in manufacturing and selling a transportation device, it is advantageous to decide to mount the semiconductor device according to the present embodiment on the transportation device in terms of improving the performance of the transportation device itself. In particular, the photoelectric conversion device 100 is suitable for a transportation device that performs driving support and/or automatic driving of the transportation device using information obtained by the semiconductor device.

### Modified Embodiments

The present disclosure is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

Further, the disclosure of the present specification includes not only the matters described in the present specification but also all matters which may be grasped from the present specification and the drawings attached to the present specification. Also, the disclosure herein includes a complement of the concepts described herein. In other words, for example, when there is a description of “A is larger than B” in this specification, it can be said that the description of “A is not larger than B” is disclosed in this specification even when the description of “A is not larger than B” is omitted. This is because it is assumed that the case where “A is not larger than B” is considered when “A is larger than B” is described.

Further, the circuit configuration of the pixel 12 is not limited to the above-described embodiments. For example, a switch such as a transistor may be provided between the photoelectric conversion element 22 and the quenching element 32 or between the photoelectric conversion element 22 and the signal processing unit 30 to control the electrical connection state therebetween. Further, a switch such as a transistor may be provided between the node to which the voltage VH is supplied and the quenching element 32 and/or between the node to which the voltage VL is supplied and the photoelectric conversion element 22 to control an electrical connection state therebetween.

The photoelectric conversion systems described in the third and fourth embodiments are examples of photoelectric conversion systems to which the photoelectric conversion device of the present disclosure may be applied, and the photoelectric conversion system to which the photoelectric conversion device of the present disclosure may be applied is not limited to the configuration illustrated in FIG. 16 and FIG. 17A.

According to the present disclosure, it is possible to reduce the circuit scale of a pixel in a photoelectric conversion device having a function of time-domain correlation imaging.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011539, filed Jan. 27, 2025, which is hereby incorporated by reference herein in its entirety.

What is claimed is:

1. A photoelectric conversion device comprising:
a light receiving unit including an avalanche photodiode and configured to output a photon detection signal in response to incidence of a photon;
a first integration unit configured to integrate a first signal obtained by weighting the photon detection signal based on first weight information;
a second integration unit configured to integrate a second signal obtained by weighting the photon detection signal based on second weight information related to weighting of a time-domain correlation for calculating an optical flow; and
a control unit configured to output a first control signal that controls an output of the first signal from the light receiving unit to the first integration unit and a second control signal that controls an output of the second signal from the light receiving unit to the second integration unit,
wherein number of asserted periods of the second control signal in a unit exposure period is smaller than number of asserted periods of the first control signal in the unit exposure period.

2. The photoelectric conversion device according to claim 1,
wherein the second weight information is set based on values of a periodic function having a unit exposure period including a plurality of sub-exposure periods as one cycle, and
wherein the second weight information provided in each of the plurality of sub-exposure periods corresponds to a value of the periodic function in a phase corresponding to each of the plurality of sub-exposure periods.

3. The photoelectric conversion device according to claim 2, wherein the first weight information is the same in each of the plurality of sub-exposure periods.

4. The photoelectric conversion device according to claim 2, wherein number of subframe periods in which an integration operation in the second integration unit among the plurality of sub-exposure periods is performed is smaller than number of subframe periods in which an integration operation in the first integration unit among the plurality of sub-exposure periods is performed.

5. The photoelectric conversion device according to claim 4,
wherein the integration operation in the first integration unit is performed during an asserted period of the first control signal, and
wherein the integration operation in the second integration unit is performed during an asserted period of the second control signal.

6. The photoelectric conversion device according to claim 2, further comprising: a weight signal generation unit configured to generate a first weight signal according to the first weight information and a second weight signal according to the first weight information and the second weight information,
wherein the weight signal generation unit is configured to output the first weight signal including a plurality of pulse signals corresponding to the first weight information and the second weight signal including a plurality of pulse signals corresponding to the second weight information to the light receiving unit in each of the plurality of sub-exposure periods, and
wherein the light receiving unit is configured to output the first signal based on the first weight signal and the second signal based on the second weight signal in response to incidence of a photon.

7. The photoelectric conversion device according to claim 6, wherein the weight signal generation unit is configured to generate the first weight signal by performing thinning processing on a periodic signal including a periodic pulse signal in each of the plurality of sub-exposure periods.

8. The photoelectric conversion device according to claim 6, wherein the first integration unit is configured to integrate the number of pulse signals superimposed on the first signal input during a next sub-exposure period when a photon is incident during an immediately preceding sub-exposure period.

9. The photoelectric conversion device according to claim 6, wherein the weight signal generation unit is configured to output the second weight signal according to each of the plurality of pulse signals of the first weight signal.

10. The photoelectric conversion device according to claim 7, wherein the weight signal generation unit is configured to generate the second weight signal including the plurality of pulse signals during an asserted period of each of the plurality of pulse signals of the first weight signal by performing multiplication processing on the periodic signal input to the weight signal generation unit.

11. The photoelectric conversion device according to claim 2, wherein a bit width of an integration circuit included in the second integration unit is set based on an average value of the periodic function.

12. The photoelectric conversion device according to claim 2, wherein the periodic function is a sine function or a cosine function.

13. The photoelectric conversion device according to claim 1, wherein the light receiving unit includes a first light receiving unit configured to output the first signal in response to incidence of a photon on a first avalanche photodiode, and a second light receiving unit configured to output the second signal in response to incidence of a photon on a second avalanche photodiode.

14. The photoelectric conversion device according to claim 1, further comprising a weight signal generation unit configured to generate a first weight signal according to the first weight information and a second weight signal according to the first weight information and the second weight information,
wherein the light receiving unit further includes:
a waveform shaping circuit connected to the avalanche photodiode;
a first logic circuit configured to perform a recharge operation of the avalanche photodiode in a period in which an asserted period of the first weight signal and an asserted period of a third control signal overlap each other;
a second logic circuit configured to output the first weight signal to the first integration unit during an asserted period of the first control signal; and
a third logic circuit configured to output the second weight signal to the second integration unit during an asserted period of the second control signal.

15. The photoelectric conversion device according to claim 14,
wherein the first integration unit includes:
a flip-flop circuit configured to receive an output signal of the waveform shaping circuit and have an output signal at a level of the output signal of the waveform shaping circuit according to the third control signal;
a fourth logic circuit configured to output the first weight signal from the second logic circuit during an asserted period of the output signal of the flip-flop circuit; and
a first integration circuit configured to integrate the first signal output from the fourth logic circuit, and
wherein the second integration unit includes:
a fifth logic circuit configured to output the second weight signal from the third logic circuit during the asserted period of the output signal of the flip-flop circuit; and
a second integration circuit configured to integrate the second signal output from the fifth logic circuit.

16. The photoelectric conversion device according to claim 13, further comprising: a weight signal generation unit configured to generate a first weight signal according to the first weight information and a second weight signal according to the first weight information and the second weight information,
wherein the first light receiving unit further includes:
a first waveform shaping circuit connected to the first avalanche photodiode;
a first logic circuit configured to perform a recharge operation of the first avalanche photodiode in a period in which an asserted period of the first weight signal and an asserted period of a third control signal overlap each other; and
a second logic circuit configured to output the first weight signal to the first integration unit during an asserted period of the first control signal, and
wherein the second light receiving unit further includes:
a second waveform shaping circuit connected to the second avalanche photodiode;
a third logic circuit configured to perform a recharge operation of the second avalanche photodiode in a period in which an asserted period of the second weight signal and an asserted period of a fourth control signal overlap each other; and
a fourth logic circuit configured to output the second weight signal to the second integration unit during an asserted period of the second control signal.

17. The photoelectric conversion device according to claim 16,
wherein the first integration unit includes:
a first flip-flop circuit configured to receive an output signal of the first waveform shaping circuit and have an output signal at a level of the output signal of the first waveform shaping circuit according to the third control signal;
a fifth logic circuit configured to output the first weight signal from the second logic circuit during an asserted period of the output signal of the first flip-flop circuit; and
a first integration circuit configured to integrate the first signal output from the fifth logic circuit, and
wherein the second integration unit includes:
a second flip-flop circuit configured to receive an output signal of the second waveform shaping circuit and have an output signal at a level of the output signal of the second waveform shaping circuit according to the fourth control signal;
a sixth logic circuit configured to output the second weight signal from the fourth logic circuit during an asserted period of the output signal of the second flip-flop circuit; and
a second integration circuit configured to integrate the second signal output from the sixth logic circuit.

18. A photoelectric conversion system comprising:
the photoelectric conversion device according to claim 1; and
a signal processing device configured to process a signal output from the photoelectric conversion device.

19. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

20. A method of driving a photoelectric conversion device including a light receiving unit including an avalanche photodiode and configured to output a photon detection signal in response to incidence of a photon, a first integration unit configured to integrate a first signal obtained by weighting the photon detection signal based on first weight information, and a second integration unit configured to integrate a second signal obtained by weighting the photon detection signal based on second weight information related to weighting of a time-domain correlation for calculating an optical flow, the method comprising:
controlling an output of the first signal from the light receiving unit to the first integration unit by a first control signal; and
controlling an output of the second signal from the light receiving unit to the second integration unit by a second control signal in which number of asserted periods per unit exposure period is smaller than that of the first control signal.
